(19) United States
(12) Patent Application Publication
(10) Pub. No.: US 2004/0189548 A1
(43) Pub. Date: Sep. 30, 2004

(54) Circuit element, signal processing circuit, control device, display device, method of driving display device, method of driving circuit element, and method of driving control device

(75) Inventors: Yukihisa Takeuchi, Nishikamo-Gun (JP); Tsutomu Nanataki, Toyoake-City (JP); Iwao Ohwada, Nagoya-City (JP); Takayoshi Akao, Kasugai-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/810,078

(22) Filed: Mar. 26, 2004

Related U.S. Application Data
(60) Provisional application No. 60/457,719, filed on Mar. 26, 2003.

(30) Foreign Application Priority Data
Feb. 23, 2004 (JP) 2004-046862

(51) Int. Cl. G09G 3/20

(52) U.S. Cl. 345/55

(57) ABSTRACT

A circuit element comprises a first lead wire; a second lead wire; a third lead wire; first and second rectifying elements which are connected in series in a forward direction between the first lead wire and the second lead wire; and a load which is connected between the third lead wire and a connection point between the first and second rectifying elements. V1≧V2 over an entire operating period provided that V1 represents an electric potential of the first lead wire and V2 represents an electric potential of the second lead wire. V2≦V3≦V1 in a period in which a current is blocked and does not flow into the load, provided that V3 represents an electric potential of the connection point.

### BACKGROUND OF THE INVENTION

1. Field of the Invention:

The present invention relates to a circuit element which has a simple structure and which is usable for circuits for various applications, a signal processing circuit which includes the circuit element, a control device which includes the circuit element, a display device to which the circuit elements are applied as picture elements (image pixels), a method of driving the display device, a method of driving the circuit element, and a method of driving the control device.

2. Description of the Related Art:

In general, when a large number of circuit elements are arranged in a matrix form to selectively drive an arbitrary circuit element from the circuit elements, it is conceived to use, for example, a passive matrix driving system as shown in FIG. 43 or an active matrix driving system using nonlinear resistance elements 1000 as shown in FIG. 44.

The driving systems as described above are constructed such that the circuit elements 1004 having capacitive loads 1002 are arranged in the matrix form. In the case of the exemplary system shown in FIG. 43, one terminal of the capacitive load 1002 is connected to a select line 1006, and the other terminal is connected to a signal line 1008. In the system shown in FIG. 44, one terminal of the capacitive load 1002 is connected to a select line 1006 via a nonlinear resistance element 1000, and the other terminal is connected to a signal line 1008.

A conventional system, in which the passive matrix driving system is applied to a display device, is described in Japanese Laid-Open Patent Publication No. 2003-17245, and a conventional system, in which the active matrix driving system is applied to a display device, is described in Japanese Laid-Open Patent Publication No. 2002-108310, for example.

In the system shown in FIG. 43, the circuit element 1004 on an unselected row is affected by the signal which is supplied to the circuit element 1004 on the selected row. This results in the increase of electric power-consumption. When the system is applied to the display device, the picture element on the unselected row is affected by the signal supplied to the picture element on the selected row. Therefore, the memory effect (accumulation of electric charge in the capacitive load 1002) is not obtained for each of the picture elements. Such a system is disadvantageous to realize the high luminance or brightness and the high contrast.

In the system shown in FIG. 44, the nonlinear resistance element 1000 has a current-voltage characteristic as shown in FIG. 45. Therefore, in order to retain or hold the voltage (accumulate the electric charge) of the capacitive load 1002, it is necessary to prepare the nonlinear resistance element 1000 in which the threshold voltage Vth has a value larger than that of the holding voltage. For this reason, a high driving voltage is required, and the electric power consumption is increased.

Further, characteristics required for the nonlinear resistance element 1000 is high. For example, a stable threshold value voltage Vth, a steep nonlinear characteristic, and a small capacitance upon the breaking are required. It is difficult to manufacture such a nonlinear resistance element 1000.

In the circuit element 1004 on the unselected row, the. voltage is divided between the capacitance of the nonlinear resistance element 1000 and the capacitance of the capacitive load 1002, and the voltage of the capacitive load 1002 is lowered. Therefore, it is necessary to apply a larger charging voltage in consideration of the decrease in voltage upon the unselection. Further, the voltage level applied to the capacitive load 1002 is dispersed by the division of the voltage for each of the circuit elements 1004. For this reason, it is impossible to apply stable charging voltage to each of the capacitive loads 1002.

### SUMMARY OF THE INVENTION

The present invention has been made taking the foregoing problems into consideration, and an object thereof is to provide a circuit element, a signal processing circuit, and a control device in which the circuit element in the unselected state is not affected by a signal supplied to another circuit element in the selected state, it is possible to realize low electric power consumption, and the driving can be performed at a low voltage.

Another object of the present invention is to provide a display device and a method of driving the display device in which a picture element in the unselected state is not affected by another picture element in the selected state, it is possible to realize the memory effect in each picture element, and it is possible to realize a high luminance and a high contrast.

Still another object of the present invention is to provide a method of driving a circuit element and a method of driving a control device in which the circuit element in the unselected state is not affected by a signal supplied to another circuit element in the selected state, it is possible to realize low electric power consumption, and the driving can be performed at a low voltage.

According to the present invention, there is provided a circuit element comprising a first lead wire; a second lead wire; a third lead wire; first and second rectifying elements which are connected in series in a forward direction between the first lead wire and the second lead wire; and a load which is connected between the third lead wire and a connection point between the first and second rectifying elements.

It may be assumed that this invention is applied to a system in which a plurality of the circuit elements are arranged in a matrix form, and an arbitrary circuit element is selected/unselected by using, for example, a signal supplied from the first lead wire. On this assumption, the two rectifying elements undergo the reverse bias for the circuit element which is in the unselected state, and it is possible to allow them to function to block the current. Therefore, the circuit element, which is in the unselected state, is not affected by any signal supplied to the circuit element in the selected state. As a result, it is possible to realize the low electric power consumption, and it is possible to perform the driving at a low voltage.

Further, it is sufficient that the rectifying element has such an extremely simple and general function that the current flows in one direction only. Therefore, it is easy to obtain stable characteristics. As for the rectifying element, the threshold value voltage in the forward direction is small, and the equivalent capacitance in the backward direction is small. Therefore, the voltage, which is applied to the load in the unselected state, is an accurate voltage (voltage approximately as exactly as designed). It is almost unnecessary to increase the driving voltage even when the rectifying elements are inserted.

The driving can be performed at a low voltage as compared with the conventional passive matrix driving system and active matrix driving system based on the use of the nonlinear resistance element. The circuit is simply constructed, which is advantageous to reduce the cost, as compared with the conventional active matrix driving system based on the use of TFT. Further, the present invention is also applicable to a case in which higher voltage resistance is required, to which it is difficult to apply any conventional TFT.

It is preferable that V1≦V2 over an entire operating period provided that V1 represents an electric potential of the first lead wire and V2 represents an electric potential of the second lead wire.

In the operating period, when a first period in which a current flows from the third lead wire to the load is set, it is preferable that V1<V3 in the first period provided that V3 represents an electric potential of the connection point.

When a second period, in which a current flows from the second lead wire to the load, is set in the operating period, it is preferable that V2>V3 in the second period.

When a third period, in which the current is blocked, is set in the operating period, it is preferable that V2≦V3≦V1 in the third period.

The rectifying element may be a diode. In this configuration, the diode may be a thin film diode. The thin film diode may be an MIM (Metal Insulator Metal) element. Alternatively, the rectifying element may be formed by using a three-terminal element such as MOS transistor, bipolar transistor, or TFT.

In particular, the configuration of the rectifying element with the MIM element is especially effective, for example, when a large number of circuit elements are arranged and integrated and/or when a circuit element or a device, which is of the thin type, is constructed. A large number of circuit elements may be formed, for example, on a ceramic substrate or a silicon wafer. Alternatively, a load may be preferably connected to a circuit in which the rectifying element is formed on the substrate as described above.

Any element may exist between the first and second rectifying elements, without deviating from the gist or essential characteristics of the present invention. For example, a resistance element or an inductor may be inserted and connected in order to effect the protection, for example, when the through-current is generated by any abnormal voltage and/or in order to avoid the rush current and/or reduce the noise. The additional element may exist between the first lead wire and the first rectifying element, between the second lead wire and the second rectifying element, between the third lead wire and the load, between the load and the first rectifying element, or between the load and the second rectifying element.

When the electric potential of the second lead wire becomes higher than the electric potential of the first lead wire, the through-current may flow to destroy the circuit element. In order to avoid such an inconvenience, it is also preferable that an element such as a bypass capacitor, a Zener diode, and a varistor is inserted between the first lead wire and the second lead wire separately from the circuit element to protect the circuit element.

In another aspect, the present invention provides a signal processing circuit comprising a circuit element and a control circuit; wherein (1) the circuit element includes a first lead wire; a second lead wire; a third lead wire; first and second rectifying elements which are connected in series in a forward direction between the first lead wire and the second lead wire; and a load which is connected between the third lead wire and a connection point between the first and second rectifying elements; and (2) the control circuit controls at least an electric potential of the first lead wire and an electric potential of the second lead wire.

Accordingly, when the signal processing circuit concerning the present invention is used, then it is possible to configure a system in which the low electric power consumption can be realized and the driving can be performed at a low voltage. In this configuration, a large number of the circuit elements may be prepared, and the circuit elements may be arbitrarily arranged. Thus, it is possible to control the voltage and the current of each of the circuit elements.

The signal processing circuit according to the present invention is also applicable to the driving of a large number of circuit elements which are arranged in a matrix form. In particular, the signal processing circuit is preferably applicable to an application in which the current should flow in the two-way directions. The signal processing circuit is also preferably applicable to the driving of a circuit element in which a capacitive load is used as the load, for the following reason. For the capacitive load, the features in the present invention to allow the current to flow in the two-way directions and to retain the electric charge during the unselection are advantageous.

The signal processing circuit according to the present invention is also preferably applicable to transmission systems, for example, a transmission system in which an arbitrary bus is selected from a large number of buses, and a signal is supplied to the selected bus. In this case, it is possible to obtain the transmission system which is capable of smoothly switching without using any switching circuit and without causing any crosstalk between the buses.

In still another aspect, the present invention provides a control device comprising a plurality of circuit elements and a plurality of control circuits; wherein (1) each of the circuit elements includes a first lead wire; a second lead wire; a third lead wire; first and second rectifying elements which are connected in series in a forward direction between the first lead wire and the second lead wire; and a load which is connected between the third lead wire and a connection point between the first and second rectifying elements; and (2) each of the control circuits controls electric potentials of the first lead wire, the second lead wire, and the third lead wire.

Accordingly, when the control device concerning the present invention is used, then it is possible to configure a system in which the low electric power consumption can be realized and the driving can be performed at a low voltage. In this configuration, a large number of circuit elements may be prepared, and the circuit elements may be arbitrarily arranged. Thus, it is possible to control the voltage and the current of each of the circuit elements.

Further, the control device according to the present invention is usable for the display device as described later on as well as optical switches, MEMS (micro electro mechanical system), memories, printers, position control devices, and space optical modulation elements, and so on.

It is preferable that V1≧V2 over an entire operating period provided that V1 represents the electric potential of the first lead wire and V2 represents the electric potential of the second lead wire.

When a selection period and an unselection period are set for each of the circuit elements in the operating period, it is preferable that V2≦V3≦V1 in the unselection period provided that V3 represents an electric potential of the connection point. It is preferable that V1<V3 or V2>V3 while each of the circuit elements is actually selected in the selection period.

The meaning of the phrase “actually selected” will now be explained. First, the selection period means a period in which each of the circuit elements can be selected or changed into a selected state. The relationship of length between the selection period and the period in which each of the circuit elements is actually selected is: (selection period)≧(period in which each of the circuit elements is actually selected). The start time point of the selection period may be different from the start time point of the period in which each of the circuit elements is actually selected. Further, in the selection period, some of the circuit elements might not be selected. The relationship of V1<V3 or V2>V3, which is the feature of the present invention, indicates the relationship of the electric potential in the period in which each of the circuit elements is actually selected, as described above. Thus, if the length of the period in which each of the circuit elements is actually selected is the same as that of the selection period, the relationship of V1<V3 or V2>V3 in the selection period can be defined. However, if the length of the period in which each of the circuit elements is actually selected is shorter than the selection period or zero, the definition cannot always be made such that V1<V3 or V2>V3 in the selection period. Accordingly, in the present invention, the definition is made such that “V1<V3 or V2>V3 while each of the circuit elements is actually selected in the selection period”.

When a reset period is set for each of the circuit elements in the operating period, it is preferable that V1<V3 or V2>V3 while each of the circuit elements is actually reset in the reset period. The meaning of the phrase “actually reset” in this definition is the same as that described above.

The load may be a displacement control element which displaces a control objective on the basis of a voltage applied to the load. In this arrangement, the displacement control element may include a piezoelectric element. Alternatively, the displacement control element may include at least a pair of opposing electrodes to utilize an electrostatic force exerted when a voltage is applied between at least the pair of electrodes. The displacement control element may include an inductor, and the displacement of the control objective may be controlled by the magnetic force based on a voltage applied to the inductor. The inductor may have such a characteristic that a magnetic flux density-magnetic field characteristic curve has a hysteresis, and a saturation magnetic flux density is approximately the same as a residual or remanent magnetic flux density.

In still another aspect, the present invention provides to a display device comprising a display section which includes a large number of picture elements; a large number of select lines each of which gives a selection/unselection instruction to the respective picture elements; a large number of signal lines each of which supplies a picture element signal to the respective picture elements in a selected state; and a large number of reset lines each of which supplies a reset signal to the respective picture elements in the selected state; wherein each of the picture elements includes first and second rectifying elements which are connected in series in a forward direction between two lines selected from one of the select lines, one of the signal lines, and one of the reset lines; and a load which is connected between remaining one line and a connection point between the first and second rectifying elements. The reset signal herein includes, for example, signals to be used to allow the load to perform the electric discharge and allow the load to perform the charge, and also includes a signal to be used to allow the load to be in a certain reference state.

Accordingly, the two rectifying elements undergo the reverse bias respectively for the circuit element disposed on the unselected row to successfully function so that the current is blocked. Therefore, the picture element on the unselected row is not affected by any signal supplied to the picture element disposed on the selected row. As a result, it is possible to realize the low electric power consumption, and it is possible to perform the driving at a low voltage. Further, it is possible to perform the driving while allowing the respective picture elements to have the memory effect. It is possible to realize the display device having a high luminance and a high contrast.

Of course, as described above, the driving can be performed at a low voltage as compared with the conventional passive matrix driving system and the active matrix driving system based on the use of the nonlinear resistance element. The circuit is simply configured, which is advantageous to reduce the cost, as compared with the conventional active matrix driving system based on the use of TFT. Further, the present invention is also applicable to a case in which higher voltage resistance is required, to which it is difficult to apply any conventional TFT.

It is preferable that V1≦V2 over an entire operating period provided that the line selected from the select line, the signal line, and the reset line, to which a cathode of the first rectifying element is connected, is defined as a first line, and the line, to which an anode of the second rectifying element is connected, is defined as a second line; and V1 represents an electric potential of the first line, and V2 represents an electric potential of the second line.

It is preferable that V2≦V3≦V1 in an unselection period provided that a selection period and the unselection period are set for each of the picture elements in the operating period; and V3 represents an electric potential of the connection point.

It is preferable that V1<V3 or V2>V3 while each of the circuit elements is actually selected in the selection period. When a reset period is set for each of the picture elements in the operating period, it is preferable that V1<V3 or V2>V3 while each of the circuit elements is actually reset in the reset period.

In still another aspect, the present invention provides a method of driving a display device comprising a display section which includes a large number of picture elements; a large number of select lines each of which gives a selection/unselection instruction to the picture elements; a large number of signal lines each of which supplies a picture element signal to the picture elements in a selected state; and a large number of reset lines each of which supplies a reset signal to the picture elements in the selected state; each of the picture elements including first and second rectifying elements which are connected in series in a forward direction between two lines selected from one of the select lines, one of the signal lines, and one of the reset lines; and a load which is connected between remaining one line and a connection point between the first and second rectifying elements; wherein a picture element in the selected state is driven so that V1<V3 or V2>V3; and a picture element in the unselected state is driven so that V2≦V3≦V1 provided that the a line selected from the one of the select lines, the one of the signal lines, and the one of the reset lines, to which a cathode of the first rectifying element is connected, is defined as a first line, and a line selected from the one of the select lines, the one of the signal lines, and the one of the reset lines, to which an anode of the second rectifying element is connected, is defined as a second line; and V1 represents an electric potential of the first line, V2 represents an electric potential of the second line, and V3 represents an electric potential of the connection point of the picture element.

Accordingly, the picture element, which is in the unselected state, is not affected by the signal supplied to the picture element in the selected state, and the memory effect can be realized for each of the picture elements. Thus, it is possible to realize a high luminance and a high contrast.

A picture element, which has the following light emission characteristic, may be used as the picture element. A first voltage and a second voltage are applied to the load, and light is emitted while the second voltage is applied.

In this procedure, a light emission luminance of the picture element may be changed depending on a gradation level by changing the end time point of the second voltage by modulating a pulse width of the picture element signal supplied to the picture element depending on the gradation level of the picture element.

A light emission luminance of the picture element may be changed depending on a gradation level by changing an amplitude of the second voltage by controlling an amplitude of the picture element signal supplied to the picture element depending on the gradation level of the picture element.

A light emission luminance of the picture element may be changed depending on a gradation level by changing the start time point of the second voltage state by modulating a phase of a trigger signal included in the picture element signal supplied to the picture element depending on the gradation level of the picture element.

A light emission luminance of the picture element may be changed depending on a gradation level by changing an amplitude of the second voltage by modulating a pulse width of the picture element signal supplied to the picture element depending on the gradation level of the picture element.

When the picture element has a characteristic that a light amount is changed depending on a duty ratio of a period of the first voltage with respect to a predetermined period, a light emission luminance of the picture element may be changed depending on a gradation level by changing a pulse width of the first voltage by modulating a phase of a trigger signal included in the picture element signal supplied to the picture element depending on the gradation level of the picture element.

When the picture element has a characteristic that a light amount is changed depending on an accumulated voltage in the first voltage, a light emission luminance of the picture element may be changed depending on a gradation level by changing an amplitude of the first voltage by modulating a pulse width of the picture element signal supplied to the picture element depending on the gradation level of the picture element.

When the picture element has such a characteristic that a light amount is changed depending on an accumulated voltage in the first voltage, a light emission luminance of the picture element may be changed depending on a gradation level by changing an amplitude of the first voltage by modulating an amplitude of the picture element signal supplied to the picture element depending on the gradation level of the picture element.

In the procedures as described above, when the first voltage and the second voltage are continuously applied to the load, it is preferable since more intense and stable light emission is obtained.

Alternatively, any picture element, which has the following light emission characteristic, may be used as the picture element. The picture element has a light emission characteristic that a first voltage, a reference voltage, and a second voltage having a polarity opposite to that of the first voltage are applied to the load, and thus light emission is effected at least in an application period of the first voltage and an application period of the second voltage.

In this procedure, a light emission luminance of the picture element may be changed depending on a gradation level by changing a start time point of the first voltage and a start time point of the second voltage by modulating a phase of a trigger signal included in the picture element signal supplied to the picture element depending on the gradation level of the picture element.

A light emission luminance of the picture element may be changed depending on a gradation level by changing an amplitude of the first voltage and an amplitude of the second voltage by modulating a pulse width of the picture element signal supplied to the picture element depending on the gradation level of the picture element.

A light emission luminance of the picture element may be changed depending on a gradation level by changing an amplitude of the first voltage and an amplitude of the second voltage by modulating an amplitude of the picture element signal supplied to the picture element depending on the gradation level of the picture element.

In still another aspect, the present invention provides a method of driving an array of circuit elements, the array comprising a plurality of circuit elements, a plurality of first lead wires, a plurality of second lead wires, and a plurality of third lead wires, a first group comprising the plurality of first lead wires, a second group comprising the plurality of second lead wires, at least one of the first group and the second group giving a selection/unselection instruction to the circuit elements, and each of the circuit elements including: a first rectifying element and a second rectifying element which are connected in series in a forward direction respectively between two lead wires selected from one of the first lead wires, one of the second lead wires, and one of the third lead wires; and a load which is connected between remaining one lead wire and a connection point between the first rectifying element and second rectifying element, wherein a selected circuit element in a selected state is driven so that V1<V3 or V2>V3; and an unselected circuit element in an unselected state is driven so that V2≦V3≦V1, provided that a lead wire selected from one of the first lead wires, one of the second lead wires, and one of the third lead wires, to which a cathode of the first rectifying element is connected, being defined as a first lead wire, and a lead wire selected from one of the first lead wires, one of the second lead wires, and one of the third lead wires, to which an anode of the second rectifying element is connected, being defined as a second lead wire; and V1 represents an electric potential of the first lead wire, V2 represents an electric potential of the second lead wire, and V3 represents an electric potential of the connection point.

Accordingly, it is possible to contemplate the low electric power consumption of the circuit element, and it is possible to perform the driving at a low voltage. Therefore, when the method of driving the circuit element is used for a variety of applications, it is possible to realize the low electric power consumption and the low voltage driving of each of the applications.

In still another aspect, the present invention provides a method of driving a control device, the control device comprising: a plurality of circuit elements; a large number of select lines each of which gives a selection/unselection instruction to the respective circuit elements; a large number of signal lines each of which supplies a signal to the respective circuit elements in a selected state; and a large number of reset lines each of which supplies a reset signal to the respective circuit elements in the selected state, wherein each of the circuit elements includes: a first rectifying element and a second rectifying element which are connected in series in a forward direction respectively between two lines selected from one of the select lines, one of the signal lines, and one of the reset lines; and a load which is connected between remaining one line and a connection point between the first rectifying element and second rectifying element, wherein a selected circuit element in the selected state is driven so that V1<V3 or V2>V3; and an unselected circuit element in an unselected state is driven so that V2≦V3≦V1, provided that a line selected from one of the select lines, one of the signal lines, and one of the reset lines, to which a cathode of the first rectifying element is connected, is defined as a first line, and a line selected from one of the select lines, one of the signal lines, and one of the reset lines, to which an anode of the second rectifying element is connected, is defined as a second line; and V1 represents an electric potential of the first line, V2 represents an electric potential of the second line, and V3 represents an electric potential of the connection point.

In this arrangement, the load may include a piezoelectric element, and the displacement of the control objective may be controlled by using the inverse piezoelectric effect of the piezoelectric element. Alternatively, at least a pair of opposing electrodes may be provided, and the displacement of the control objective may be controlled by using the electrostatic force exerted when the voltage is applied between at least the pair of electrodes.

In still another aspect, the present invention provides a method of driving a control device, the control device comprising a plurality of circuit elements, each of the circuit elements including: a first lead wire which gives displacement instruction in a positive direction, a second lead wire which gives displacement instruction in a negative direction, a third lead wire which gives a displacement amount instruction, a first rectifying element and a second rectifying element which are connected in series in a forward direction between the first lead wire and the second lead wire, and a load which is connected between the third lead wire and a connection point between the first rectifying element and the second rectifying element, wherein a circuit element, for which the displacement instruction in the positive direction is given, is driven so that V1≧V2 and V3>V1 at a displacement start time point; a circuit element, for which the displacement instruction in the negative direction is given, is driven so that V1≧V2 and V3<V2 at a displacement start time point; and a circuit element, which is in an unselected state, is driven so that V2≦V3≦V1, provided that V1 represents an electric potential of the first lead wire, V2 represents an electric potential of the second lead wire, and V3 represents an electric potential of the connection point.

In this arrangement, the load may include an inductor, and the displacement of the control objective may be controlled by the magnetization of the inductor controlled by the current flowing through the inductor depending on the voltage. The inductor may have a characteristic that a magnetic flux density-magnetic field characteristic curve has a hysteresis, and a saturation magnetic flux density is approximately the same as a residual or remanent magnetic flux density. The load may include a piezoelectric element, and the displacement of the control objective may be controlled by using the inverse piezoelectric effect of the piezoelectric element. Alternatively, at least a pair of opposing electrodes may be provided, and the displacement of the control objective may be controlled by using the electrostatic force exerted when the voltage is applied between at least the pair of electrodes.

In the method of driving the control device described above, the circuit element, which is in the unselected state, is not affected by the signal to be supplied to the circuit element which is in the selected state. It is possible to contemplate the low electric power consumption, and it is possible to perform the driving at a low voltage.

As explained above, according to the circuit element, the signal processing circuit, and the control device concerning the present invention, the circuit element, which is in the unselected state, is not affected by the signal to be supplied to the circuit element which is in the selected state. It is possible to contemplate the low electric power consumption, and it is possible to perform the driving at a low voltage.

Further, according to the display device and the method of driving the display device concerning the present invention, the picture element, which is in the unselected state, is not affected by the signal to be supplied to the picture element which is in the selected state. It is possible to realize the memory effect in each of the picture elements, and it is possible to realize the high luminance and the high contrast.

Further, according to the method of driving the circuit element and the method of driving the control device concerning the present invention, the circuit element, which is in the unselected state, is not affected by the signal to be supplied to the circuit element which is in the selected state. It is possible to contemplate the low electric power consumption, and it is possible to perform the driving at a low voltage.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a configuration illustrating a circuit element according.to an embodiment of the present invention;

FIG. 2 shows a configuration illustrating a signal processing circuit according to an embodiment of the present invention;

FIG. 3 shows the electric potentials in the operating period for the signal processing circuit according to the embodiment of the present invention;

FIG. 4 shows a configuration illustrating a display device according to a first embodiment;

FIG. 5 shows a characteristic of voltage-accumulated electric charge of a capacitive load to be used for the display device according to the first embodiment;

FIG. 6 shows a timing chart illustrating an exemplary driving system for the display device according to the first embodiment;

FIG. 7 shows a diagram illustrating the timing to be used when the driving system for the display device according to the first embodiment is applied to four-row scanning;

FIG. 8A shows a waveform to be obtained when the end time point of the first voltage state is changed by modulating the pulse width of the picture element signal;

FIG. 8B shows an exemplary light output waveform;

FIG. 8C shows another exemplary light output waveform;

FIG. 9A shows a waveform to be obtained when an amplitude of the first voltage state is changed by modulating the amplitude of the picture element signal;

FIG. 9B shows an exemplary light output waveform;

FIG. 9C shows another exemplary light output waveform;

FIG. 10 shows a configuration illustrating a display device according to a second embodiment;

FIG. 11A shows a waveform illustrating the change of the terminal voltage across a capacitive load to be used for the display device according to the second embodiment;

FIG. 11B shows the change of the light output associated with the change of the terminal voltage across the capacitive load;

FIG. 12 shows a timing chart illustrating an exemplary driving system for the display device according to the second embodiment;

FIG. 13A shows a diagram illustrating an example of the timing to be used when the driving system for the display device according to the second embodiment is applied to four-row scanning;

FIG. 13B shows a diagram illustrating another example;

FIG. 14A shows a waveform to be obtained when the phase of the trigger signal included in the picture element signal is changed;

FIG. 14B shows a case in which the start time point of the first voltage state is changed by modulating the phase;

FIG. 14C shows an example in which the light output period is changed depending on the phase of the trigger signal;

FIG. 15A shows a waveform illustrating an example in which the pulse width of the picture element signal is changed;

FIG. 15B shows a waveform to be obtained when the amplitude of the first voltage state is changed by modulating the pulse width;

FIG. 15C shows an example in which the light output level is changed depending on the pulse width of the picture element signal;

FIG. 16A shows a waveform illustrating an example in which the amplitude of the picture element signal is changed;

FIG. 16B shows a waveform illustrating a case in which the amplitude of the first voltage state is changed by modulating the amplitude;

FIG. 16C shows an example in which the light output level is changed depending on the amplitude of the picture element signal;

FIG. 17 shows a configuration illustrating a display device according to a third embodiment;

FIG. 18 shows a characteristic of duty ratio-light amount of a capacitive load to be used for the display device according to the third embodiment;

FIG. 19A shows a waveform illustrating an example in which the phase of the trigger signal included in the picture element signal is changed;

FIG. 19B shows a waveform illustrating a case in which the start time point of the second voltage state is changed by modulating the phase;

FIG. 19C shows an example in which the light output level is changed depending on the phase of the trigger signal;

FIG. 20 shows a characteristic of accumulated voltage-light amount of a capacitive load to be used for the display device according to the third embodiment;

FIG. 21A shows a waveform illustrating an example in which the pulse width of the picture element signal is changed;

FIG. 21B shows a waveform illustrating a case in which the amplitude of the second voltage state is changed by modulating the pulse width;

FIG. 21C shows an example in which the light output level is changed depending on the pulse width of the picture element signal;

FIG. 22A shows a waveform illustrating an example in which the amplitude of the picture element signal is changed;

FIG. 22B shows a waveform illustrating a case in which the amplitude of the second voltage state is changed by modulating the amplitude;

FIG. 22C shows an example in which the light output level is changed depending on the amplitude of the picture element signal;

FIG. 23 shows a timing chart illustrating an exemplary driving system for the display device according to the third embodiment;

FIG. 24 shows a configuration illustrating a display device according to a fourth embodiment;

FIG. 25 shows a timing chart illustrating an exemplary driving system for the display device according to the fourth embodiment;

FIG. 26A shows a diagram illustrating an example of the timing to be used when the driving system for the display device according to the fourth embodiment is applied to four-row scanning;

FIG. 26B shows a diagram illustrating another example;

FIG. 27A shows a waveform illustrating an example in which the phases of the trigger signal having positive polarity and the trigger signal having negative polarity included in the picture element signal are changed;

FIG. 27B shows a waveform illustrating a case in which the respective start time points of the first voltage state and the second voltage state are changed by modulating the phase;

FIG. 27C shows an example in which the light output period is changed depending on the phases of the trigger signal having positive polarity and the trigger signal having negative polarity;

FIG. 28A shows a waveform illustrating an example in which the pulse width of the picture element signal is changed;

FIG. 28B shows a waveform illustrating a case in which the respective amplitudes of the first voltage state and the second voltage state are changed by modulating the pulse width;

FIG. 28C shows an example in which the light output level is changed depending on the pulse width of the picture element signal;

FIG. 29A shows a waveform illustrating an example in which the amplitude of the picture element signal is changed;

FIG. 29B shows a waveform illustrating a case in which the respective amplitudes of the first voltage state and the second voltage state are changed by modulating the amplitude;

FIG. 29C shows an example in which the light output level is changed depending on the amplitude of the picture element signal;

FIG. 30 shows a configuration illustrating a position control device according to an embodiment of the present invention;

FIG. 31 shows a model illustrating a position control system comprising an inductor and a resistor;

FIG. 32 shows a characteristic illustrating the change of the position of a control objective depending on the magnitude and the direction of the current flowing through the inductor;

FIG. 33 shows a timing chart illustrating the control operation when the control objective is displaced in the positive direction with the position control device according to the embodiment of the present invention;

FIG. 34 shows a timing chart illustrating the control operation when the control objective is displaced in the negative direction with the position control device according to the embodiment of the present invention;

FIG. 35A shows a diagram illustrating an example of the timing when the driving system for the position control device according to the embodiment of the present invention is applied to four-row scanning;

FIG. 35B shows a diagram illustrating another example;

FIG. 36A illustrates the setting of the terminal voltage across the load when the control objective is moved in the positive direction;

FIG. 36B illustrates the setting of the terminal voltage across the load when the control objective is moved in the negative direction;

FIG. 37 shows an example of the displacement-voltage characteristic of the piezoelectric element used as the displacement control element;

FIG. 38 shows another example of the displacement-voltage characteristic of the piezoelectric element used as the displacement control element;

FIG. 39 schematically shows an optical switch array configured by arranging a large number of displacement control elements;

FIG. 40A illustrates a first state of the optical switch;

FIG. 40B illustrates a second state of the optical switch;

FIG. 41 shows an example of the B-H characteristic of the displacement control element based on the use of the coil having the large residual magnetic flux;

FIG. 42 shows a timing chart illustrating an example of the method of driving the circuit element including the displacement control element based on the use of the coil having the large residual magnetic flux;

FIG. 43 illustrates a conventional passive matrix driving system;

FIG. 44 illustrates a conventional active matrix driving system based on the use of nonlinear resistance elements; and

FIG. 45 shows a characteristic of current-voltage of the nonlinear resistance element.

### DESCRIPTION OF THE PREFERRED EMBODIMENTS

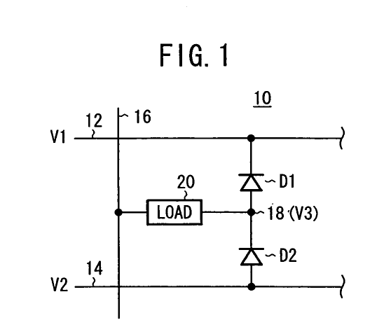

Illustrative embodiments of the circuit element, the signal processing circuit, the control device, the display device, the method of driving the display device, the method of driving the circuit element, and the method of driving the control device according to the present invention will be explained below with reference to FIGS. 1 to 42.

As shown in FIG. 1, a circuit element 10 according to an embodiment of the present invention comprises a first lead wire 12, a second lead wire 14, a third lead wire 16, first and second rectifying elements D1, D2 which are connected in series in the forward direction between the first lead wire 12 and the second lead wire 14, and a load 20 which is connected between the third lead wire 16 and a connection point 18 between the first and second rectifying elements D1, D2.

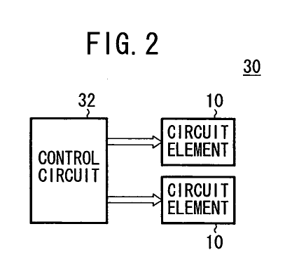

As shown in FIG. 2, a signal processing circuit 30 according to an embodiment of the present invention comprises one or more circuit elements 10 as described above and a control circuit 32. The embodiment shown in the drawing is illustrative of two circuit elements 10 and one control circuit 32.

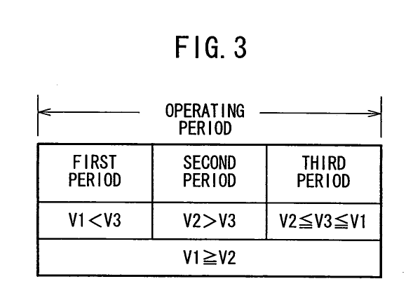

As shown in FIG. 3, the control circuit 32 makes control so that V1≧V2 over the entire operating period provided that V1 represents the electric potential of the first lead wire 12 and V2 represents the electric potential of the second lead wire 14.

The control circuit 32 makes control during the operating period as follows. That is, V1<V3 in the first period in which the current flows from the third lead wire 16 to the load 20, V2>V3 in the second period in which the current flows from the second lead wire 14 to the load 20, and V2≦V3≦V1 in the third period in which the current is prohibited from flowing into the load 20.

It is now assumed that an arbitrary circuit element 10 is selected/unselected by using, for example, a signal supplied from the first lead wire 12. On this assumption, the two rectifying elements D1, D2 undergo the reverse bias for the circuit element 10 which is in the unselected state to successfully function so that the current is cut off, because the circuit element 10 in the unselected state is in the third period of the operating period described above. The circuit element 10, which is in the selected state, is in the first period or the second period. Therefore, the circuit element 10, which is in the unselected state, is not affected by any signal supplied to the circuit element 10 in the selected state. Therefore, it is possible to realize the low electric power consumption, and it is possible to perform the driving at a low voltage in the circuit element 10 and the signal processing circuit 30 according to the embodiments of the present invention.

Further, it is sufficient that the rectifying element D1, D2 has an extremely simple and general function that the current flows only in one direction. Therefore, it is easy to obtain stable characteristics. As for the rectifying element D1, D2, the threshold value voltage in the forward direction is small, and the equivalent capacitance in the backward direction is small. Therefore, the voltage, which is applied to the load 20 in the unselected state, can be an accurate voltage (voltage approximately as exactly as designed). It is almost unnecessary to increase the driving voltage even when the rectifying elements D1, D2 are inserted.

The driving can be performed at a low voltage as compared with the conventional passive matrix driving system and the active matrix driving system based on the use of the nonlinear resistance element. The circuit is simply configured, which is advantageous to reduce the cost, as compared with the conventional active matrix driving system based on the use of TFT. Further, the present invention is also applicable to a case in which higher voltage resistance is required, to which it is difficult to apply any conventional TFT.

In the signal processing circuit 30 according to the embodiment of the present invention, a large number of the circuit elements 10 may be prepared, and the circuit elements 10 may be arbitrarily arranged to successfully control the voltage and the current of each of the circuit elements 10. Therefore, the signal processing circuit 30 can be also utilized as a control system, for example, for displacement, position, temperature, light, and pressure.

The signal processing circuit 30 is also preferably applicable to transmission systems, for example, a transmission system in which an arbitrary bus is selected from a large number of buses, and a signal is supplied to the selected bus. In this configuration, it is possible to obtain the transmission system capable of smoothly performing the switching without using any switching circuit (without generating any noise) and without causing any crosstalk between the buses.

Each of the first and second rectifying elements D1, D2 may be a diode. In this configuration, the diode may be a thin film diode. The thin film diode may be an MIM element. Alternatively, the rectifying element may be formed by using a three-terminal element such as MOS transistor, bipolar transistor, or TFT.

In particular, the configuration of the first and second rectifying elements D1, D2 with MIM elements is especially effective, for example, when a large number of circuit elements 10 are arranged and integrated, and when a thin type circuit element 10 or a thin type device is configured. A large number of circuit elements 10 may be formed, for example, on a ceramic substrate or a silicon wafer. It is also preferable that the load 20 is connected to a circuit obtained by forming the first and second rectifying elements D1, D2 on a substrate as described above.

There may be one or some elements between the first and second rectifying elements D1, D2 without deviating from the gist or essential characteristics of the present invention. For example, a resistance element or an inductor may be inserted or connected in order to protect a circuit when the through-current is generated by any abnormal voltage and/or in order to avoid the rush current and/or reduce the noise. Such an additional element may be between the first lead wire 12 and the first rectifying element D1, between the second lead wire 14 and the second rectifying element D2, between the third lead wire 16 and the load 20, between the load 20 and the first rectifying element D1, or between the load 20 and the second rectifying element D2.

When the electric potential of the second lead wire 14 becomes higher than the electric potential of the first lead wire 12, the through-current may flow to destroy the circuit element 10. In order to avoid such inconvenience, it is also preferable that an element such as a bypass capacitor, a Zener diode, and a varistor is inserted between the first lead wire 12 and the second lead wire 14 separately from the circuit element 10 to protect the circuit element 10.

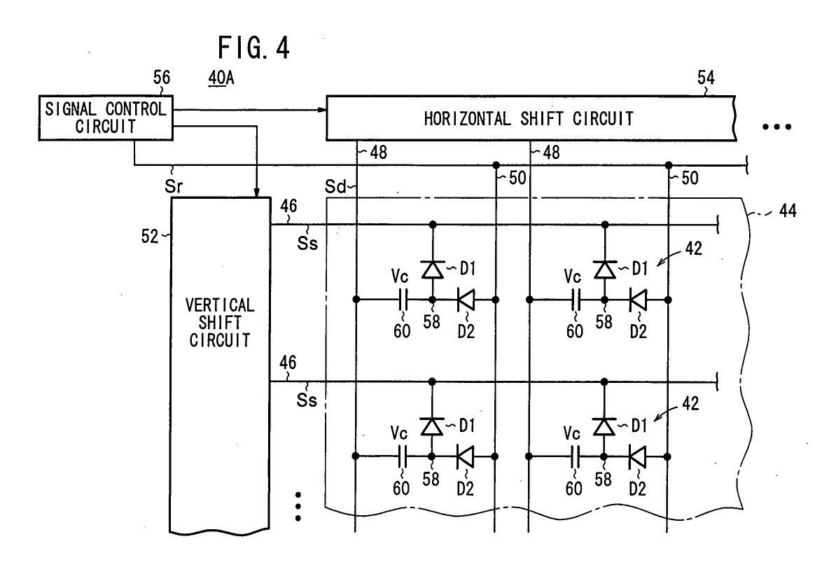

Next, an explanation will be made with reference to FIGS. 4 to 29C about illustrative embodiments in which the circuit element 10 and the signal processing circuit 30 according to the embodiments of the present invention are applied to display devices.

First, as shown in FIG. 4, a display device 40A according to a first embodiment includes a display section 44 in which a large number of picture elements 42 are arranged in a matrix form, select lines 46 whose number corresponds to the number of rows of the picture elements 42, signal lines 48 whose number corresponds to the number of columns of the picture elements 42, and reset lines 50 whose number corresponds to the number of columns of the picture elements 42.

The display device 40A further includes a vertical shift circuit 52, a horizontal shift circuit 54, and a signal control circuit 56.

The vertical shift circuit 52. selectively supplies a selection signal Ss to the select line 46 to successively select the picture elements 42 in a unit of one row. The horizontal shift circuit 54 outputs a picture element signal Sd to the signal lines 48 in parallel. A common reset signal Sr is supplied to the respective reset lines 50 by the signal control circuit 56.

The picture element 42 includes first and second rectifying elements D1, D2 which are connected in series in the forward direction between the select line 46 and the reset line 50, and a capacitive load 60 which is connected between the signal line 48 and a connection point 58 between the first and second rectifying elements D1, D2.

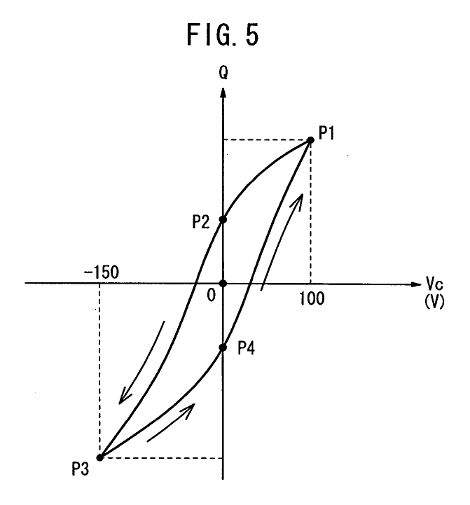

The terminal voltage Vc across the capacitive load 60 relates to the accumulated electric charge Q as shown by a characteristic in FIG. 5. That is, a hysteresis curve is depicted on the basis of a terminal voltage Vc=0. For example, when the terminal voltage Vc is changed from 100 V to −150 V, then the change is made in order of points P1→P2→P3, and the light is emitted at the point P3. After that, when the terminal voltage Vc is raised to 100 V, then the change is made in order of points P3→P4→P1 to return to the original point P1.

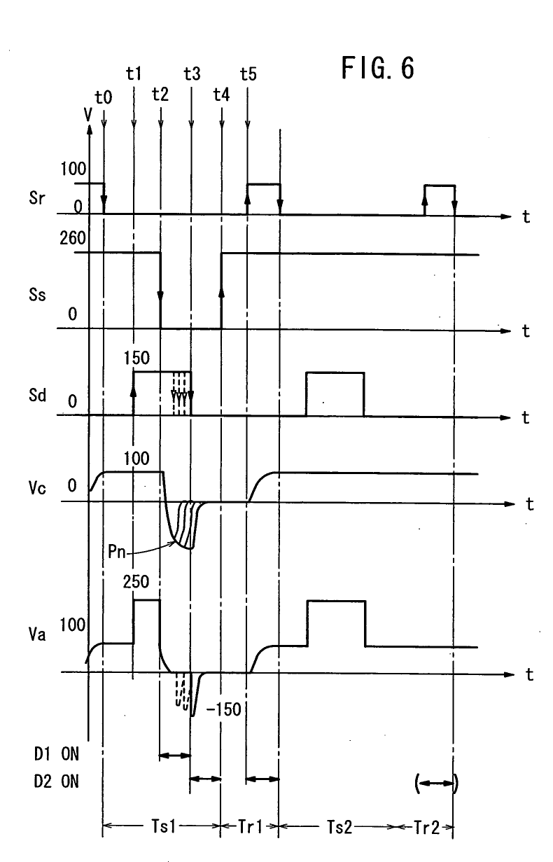

The driving system for the display device 40A will now be explained with reference to FIG. 6 as exemplified by two-row scanning. The waveform shown in FIG. 6 is illustrative of the signal waveform in relation to the picture element disposed on the first row.

First, at a time point t0, the system enters a selection period Ts1 for the picture element 42 on the first row. In this situation, the reset signal Sr is changed to the low level (for example, 0 V), the selection signal Ss maintains the high level (for example, 260 V), and the picture element signal Sd maintains the low level (for example, 0 V). The electric potential Va at the connection point 58 is 100 V. In this state, both of the first and second rectifying elements D1, D2 undergo the reverse bias as a non-conduction state. The state (first voltage state), in which the voltage having positive polarity (for example, 100 V) is applied to both ends of the capacitive load 60, is maintained.

When the picture element signal Sd is changed to high level (for example, 150 V) at the next time point t1, the electric potential Va of the connection point 58 rises up to 250 V. However, the terminal voltage Vc across the capacitive load 60 is not changed, because the selection signal Ss maintains the high level.

When the selection signal Ss is changed to the low level (for example, 0 V) at the next time point t2, the first rectifying element D1 undergoes the forward bias as a conduction state, and the electric potential Va of the connection point 58 is steeply lowered from 250 V to 0 V. Accordingly, the terminal voltage Vc across the capacitive load 60 is steeply lowered down to −150 V, and simultaneously the light is emitted by the capacitive load 60. The light emission state is maintained until the picture element signal Sd falls (until a time point t3). In other words, the capacitive load 60 has a light emission characteristic that the light emission is started at the start time point of the second voltage state Pn to be applied, and the light emission is completed at the end time point of the second voltage state Pn. Therefore, the light emission luminance, which corresponds to the gradation level of the picture element 42, can be obtained by changing the pulse width of the picture element signal Sd, especially the falling timing depending on the gradation level of the relevant picture element 42 by the signal control circuit 56.

When the picture element signal Sd is changed to the low level (for example, 0 V) at the next time point t3, the electric potential Va of the connection point 58 is lowered down to about −150 V. Accordingly, the second rectifying element D2 is in conduction, and the terminal voltage across the capacitive load 60 is 0 V.

When the system enters the reset period Tr1 for the picture element 42 on the first row at the next time point t4, and the reset signal Sr is changed to the high level (for example, 100 V) at a time point t5 thereafter, then the charge is performed in a period of time corresponding to the CR time constant of the picture element 42, and the terminal voltage Vc across the capacitive load 60 is restored to 100 V.

The system enters, from the next time point t7, the selection period Ts2 and the reset period Tr2 for the picture element 42 on the second row (unselection period for the picture element on the first row). However, the selection signal Ss for the first row maintains the high level during the periods Ts2 and Tr2. Therefore, even when the level of the picture element signal Sd is changed and the electric potential Va of the connection point 58 is changed, the levels thereof are not as high as the level of the selection signal Ss for the first row. Accordingly, the reverse bias is applied to the first and second rectifying elements D1, D2 concerning the picture element 42 on the first row, and the non-conduction state is maintained.

Therefore, the picture element 42 on the first row is not affected by the picture element signal Sd for the picture element 42 on the second row. Further, the electric charge is retained in the capacitive load 60 of the picture element 42 on the first row in the unselection period for the first row. Therefore, the electric power consumption, which is generated by the electric charge and discharge in the capacitive load 60 in the unselection period, is substantially zero. Power may be merely consumed by the parasitic capacitance (<< load capacitance).

The driving method described above is used especially when the light emission is started at the start time point of the second voltage state Pn, and the light emission is completed at the end time point. Further, the driving method is advantageous when a pulse-shaped light is emitted during the application period of the second voltage state Pn. The method is used more effectively when the wave height value and/or the duration time of the pulse-shaped light emission is changed depending on the time width and the voltage value in the second voltage state Pn.

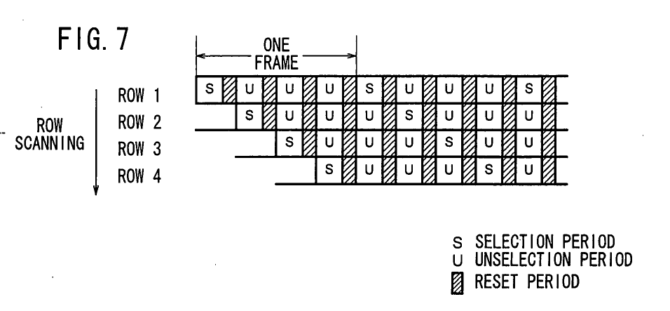

This driving system may be applied, for example, to a case of the four-row scanning. In this case, as shown in FIG. 7, assuming that one frame is in a display period for one image, the following procedure may be adopted. That is, the one frame is divided into four periods. The selection period and the reset period are set in the initial period. The unselection periods (periods in which the selection signal Ss maintains the high level) and the reset periods are set in the remaining periods. In the example shown in FIG. 7, the reset periods are set and inserted immediately after the selection period and immediately after the unselection periods in the one frame. However, one or more of the reset periods may be curtailed in the one frame.

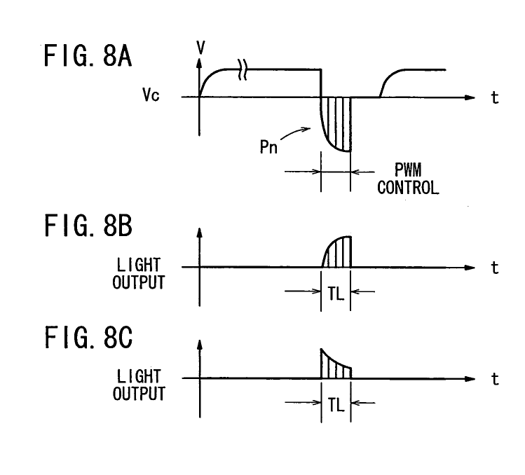

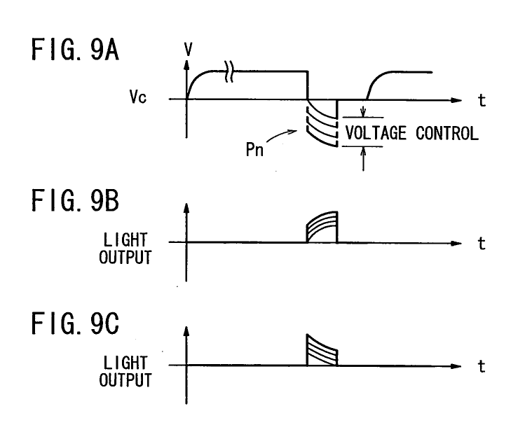

The gradation control for the picture element 42 is conducted in a system based on the pulse width modulation as shown in FIGS. 8A to 8C and a system based on the voltage control as shown in FIGS. 9A to 9C.

In the pulse width modulation system, the end time point of the second voltage state Pn is changed by. modulating the pulse width of the picture element signal Sd depending on the gradation level of the picture element (see FIG. 6), and thus the light emission luminance of the picture element 42 is changed depending on the gradation level. As for the light output waveform obtained in this procedure, as shown in FIGS. 8B and 8C, the light output period TL is changed depending on the pulse width of the picture element signal Sd.

In the voltage control system, the amplitude of the second voltage state Pn is changed as shown in FIG. 9A by controlling the amplitude of the picture element signal Sd depending on the gradation level of the picture element, and thus the light emission luminance of the picture element is changed depending on the gradation level. As for the light output waveform obtained in this procedure, as shown in FIGS. 9B and 9C, the light output level is changed depending on the amplitude of the picture element signal Sd.

As described above, in the display device 40A according to the first embodiment, the first and second rectifying elements D1, D2 undergo the reverse bias for the picture element 42 on the unselected row, and thus it is possible to allow the first and second rectifying elements D1, D2 to function so that the current is cut off. Therefore, the picture element 42 on the unselected row is not affected by the picture element signal Sd supplied to the picture element 42 on the selected row. As a result, it is possible to realize the low electric power consumption, and the driving can be performed at a low voltage. Further, the driving can be performed while allowing the respective picture elements 42 to have memory effect, and it is possible to apply a certain bias voltage during the unselection. Therefore, the operation can be performed stably without depending on the image pattern.

Of course, the driving can be performed at a low voltage as compared with the conventional passive matrix driving system and the active matrix driving system based on the use of the nonlinear resistance element as described above. Further, the circuit configuration is simple as compared with the conventional active matrix driving system based on the use of TFT, which is advantageous to realize the low cost. Further, the present invention is also applicable to a case in which higher voltage resistance is required, to which it is difficult to apply any conventional TFT.

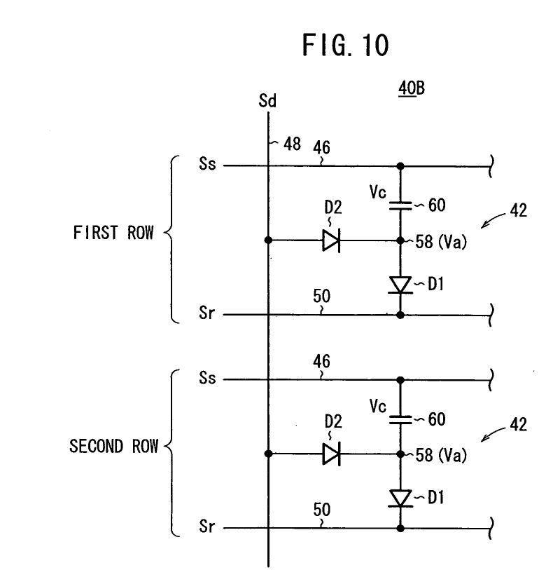

Next, a display device 40B according to a second embodiment will be explained with reference to FIGS. 10 to 16C.

The display device 40B according to the second embodiment is configured in approximately the same manner as the display device 40A according to the first embodiment described above. However, as shown in FIG. 10, the display device 40B is different from the display device 40A in that the number of reset lines 50 corresponds to the number of rows of picture elements 42, and each of select lines 46 and each of the reset lines 50 form a pair. A reset signal Sr relating to the relevant row is supplied to each of the reset lines 50, for example, by a vertical shift circuit 52. The structure of the picture element 42 slightly differs, and the light emission characteristic of the capacitive load 60 slightly differs as well.

The picture element 42 includes first and second rectifying elements D1, D2 which are connected in series in the forward direction between the reset line 50 and the signal line 48, and the capacitive load 60 which is connected between the select line 46 and a connection point 58 between the first and second rectifying elements D1, D2.

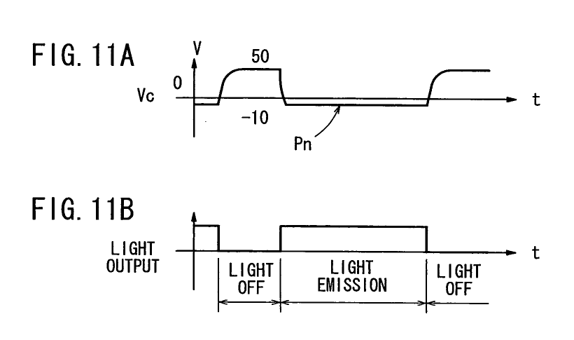

As shown in FIGS. 11A and 11B, the capacitive load 60 has a light emission characteristic that the light emission is started at the start time point of the second voltage state Pn (for example, −10 V) to be applied, and the light emission is completed at the end time point of the second voltage state Pn.

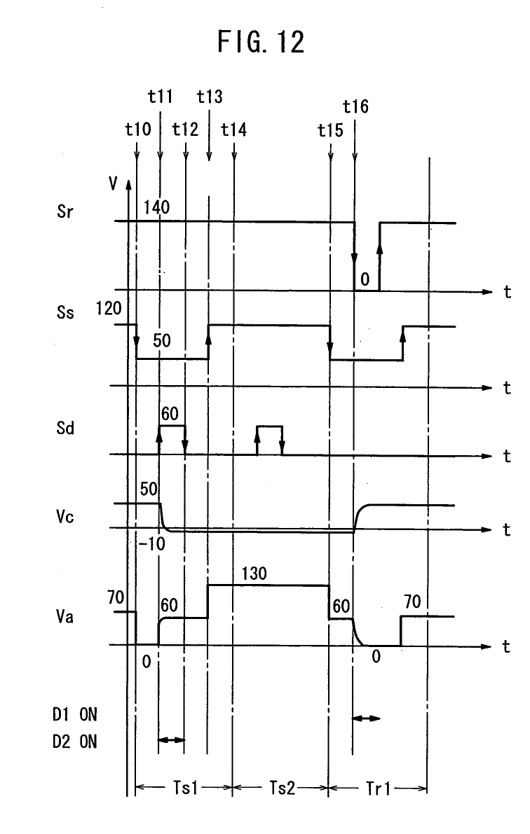

The driving system of the display device 40B will now be explained with reference to FIG. 12 as exemplified by the two-row scanning. FIG. 12 shows a timing chart in relation to the picture element disposed on the first row.

First, at a time point t10, the system enters a selection period Ts1 for the picture element on the first row. In this situation, the reset signal Sr maintains the high level (for example, 140 V), the selection signal Ss is changed to the low level (for example, 50 V), and the picture element signal Sd maintains the low level (for example, 0 V). In this state, both of the first and second rectifying elements D1, D2 undergo the reverse bias as the non-conduction state. The electric potential Va at the connection point 58 is at the level of the picture element signal Sd (0 V). The state is maintained, in which the voltage having positive polarity (for example, 50 V) is applied to both ends of the capacitive load 60.

When the picture element signal Sd is changed to the high level (for example, 60 V) at the next time point t11, the second rectifying element D2 undergoes the forward bias as the conduction state, and the electric potential Va of the connection point 58 is steeply raised from 0 V to 60 V. Accordingly, the terminal voltage Vc across the capacitive load 60 steeply drops down to −10 V, simultaneously with which the light emission is caused by the capacitive load 60. The light emission state is maintained until the reset signal Sr falls (until a time point t16).

When the picture element signal Sd is changed to the low level (0 V) at the next time point t12, the second rectifying element D2 undergoes the reverse bias again as the non-conduction state. The electric potential Va at the connection point 58 maintains 60 V, and the terminal voltage Vc across the capacitive load 60 is also maintained to be −10 V.

When the selection signal Ss is changed to the high level (for example, 120 V) at the next time point t13, the electric potential Va of the connection point 58 rises up to 130 V. However, the terminal voltage Vc across the capacitive load 60 is not changed, because the reset signal Sr maintains the high level.

The system enters a selection period Ts2 for the picture element 42 on the second row (unselection period for the first row) from the next time point t14. However, in the selection period Ts2, the reset signal Sr for the first row maintains the high level. Therefore, even when the level of the picture element signal Sd is changed, the electric potential Va at the connection point 58 is not changed. Further, the levels are not as high as the high level of the reset signal Sr for the first row. Therefore, the reverse bias is applied to the first and second rectifying elements D1, D2 concerning the picture element 42 on the first row, and the non-conduction state is maintained.

Therefore, the picture element 42 on the first row is not affected by the picture element signal Sd for the picture element 42 on the second row. Further, the electric power, which is consumed by the capacitive load 60 in the unselection period, is approximately zero, and thus the electric power consumption is considerably decreased. The capacitive load 60 continues to retain the electric charge during the unselection period, and hence it is possible to continue the light emission. Thus, it is possible to realize the high luminance and the high contrast. Even when the picture element on the first row remains in the light off state, the electric potential Va of the connection point 58 remains to be 70 V during the selection period Ts2. The reverse bias is applied to the first and second rectifying elements D1, D2 in relation to the picture element 42 on the first row, and the non-conduction state is maintained.

The system enters a reset period Tr1 for the picture element on the first row from a time point t15. When the selection signal Ss is changed to the low level, the electric potential Va of the connection point 58 is lowered down to 60 V. In this situation, the reset signal Sr maintains the high level. Therefore, the terminal voltage Vc across the capacitive load 60 is not changed.

When the reset signal Sr for the first row is changed to the low level (for example, 0 V) at the next time point t16, then the first rectifying element D1 undergoes the forward bias as the conduction state, and the electric potential Va of the connection point 58 is steeply lowered from 60 V to 0 V. Accordingly, the terminal voltage Vc across the capacitive load 60 is steeply raised up to 50 V as the initial reset state.

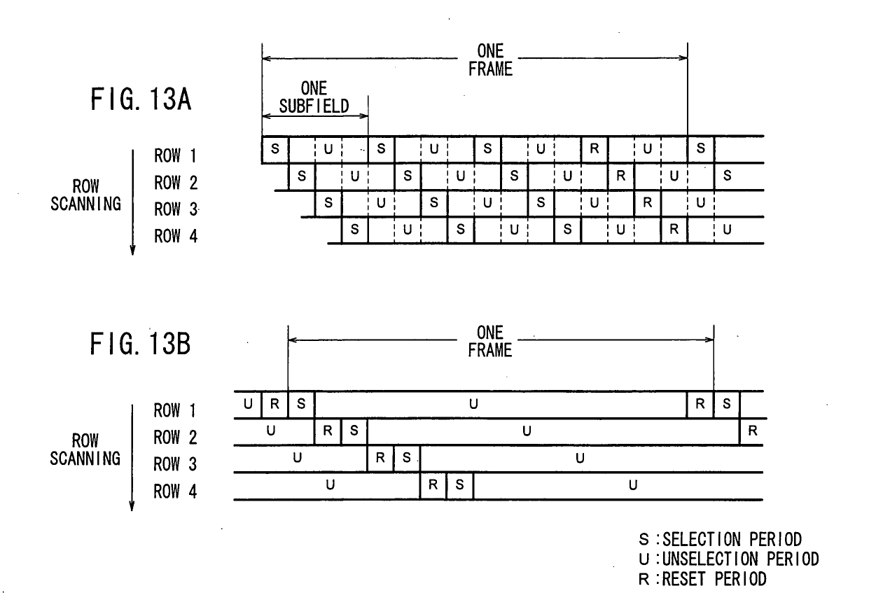

When this driving system is applied, for example, to a case of the four-row scanning, it is possible to adopt a system as shown in FIG. 13A or a system as shown in FIG. 13B.

In the system shown in FIG. 13A, one frame is divided into four periods (subfields), and one subfield is divided into four periods. As for the initial three subfields, the selection period is set for the initial period and the unselection periods are set for the remaining three periods for each of the subfields. As for the remaining one subfield, the reset period is set for the initial period, and the unselection periods are set for the remaining three periods. This system is preferably usable for the time gradation control.

On the other hand, in the system shown in FIG. 13B, one frame is divided into eight or more periods. The selection period is set for the first period of each frame, the reset period is set for the final period of each frame, and the unselection periods are set for the remaining periods. According to this system, the light off time is removed in the unselection period after the reset period, which is effective to improve the luminance.

The system shown in FIG. 13A may be combined with the system shown in FIG. 13B.

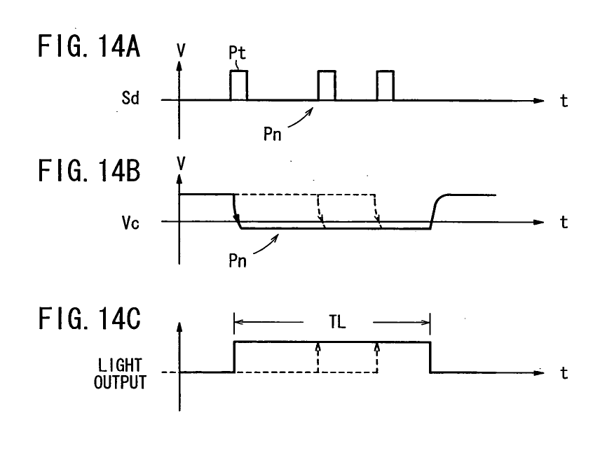

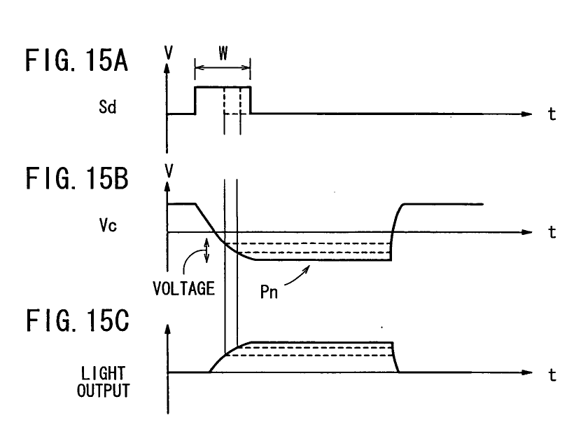

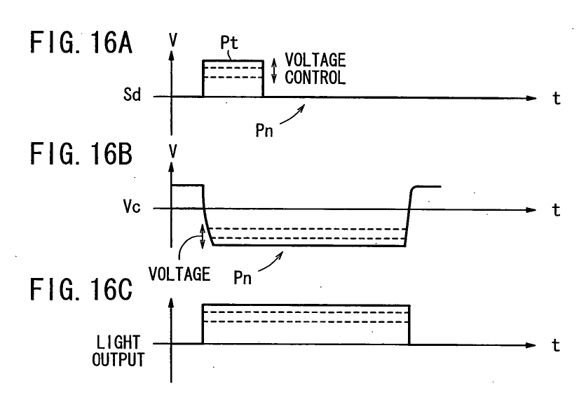

The gradation control for the picture element includes a system based on the phase modulation (time gradation control) as shown in FIGS. 14A to 14C, a system based on the pulse width modulation as shown in FIGS. 15A to 15C, and a system based on the voltage control as shown in FIGS. 16A to 16C.

In the system based on the phase modulation, the start time point of the second voltage state Pn is changed as shown in FIG. 14B by modulating the phase of the trigger signal Pt included in the picture element signal Sd depending on the gradation level of the picture element as shown in FIG. 14A. As for the light output waveform obtained in this procedure, as shown in FIG. 14C, the light output period TL is changed depending on the phase of the trigger signal Pt.

In the pulse width modulation system, the amplitude of the second voltage state Pn is changed as shown in FIG. 15B by modulating the pulse width W of the picture element signal Sd depending on the gradation level of the picture element as shown in FIG. 15A, and thus the light emission luminance of the picture element is changed depending on the gradation level. As for the light output waveform obtained in this procedure, as shown in FIG. 15C, the light output level is changed depending on the pulse width W of the picture element signal Sd.

In the voltage control system, the amplitude of the second voltage state Pn is changed as shown in FIG. 16B by controlling the amplitude of the picture element signal Sd depending on the gradation level of the picture element as shown in FIG. 16A, and thus the light emission luminance of the picture element is changed depending on the gradation level. As for the light output waveform obtained in this procedure, as shown in FIG. 16C, the light output level is changed depending on the amplitude of the picture element signal Sd. The light emission/light off and the polarity of the second voltage state Pn may be reverse to those described above by way of example. The same or equivalent effect can be obtained by only determining the voltage appropriately even in the case of the picture element in which the light emission/light off can be controlled without reversing the polarity of the second voltage state Pn.

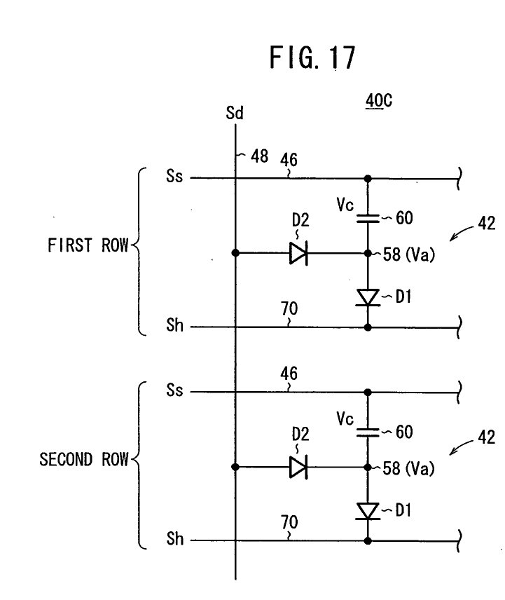

Next, a display device 40C according to a third embodiment will be explained with reference to FIGS. 17 to 23.

The display device 40C according to the third embodiment is constructed approximately in the same manner as the display device 40B according to the second embodiment described above. However, as shown in FIG. 17, the display device 40C is different from the display device 40B in that electric discharge instruction lines 70 for instructing the electric discharge of the capacitive loads 60 are arranged in place of the reset lines 50, and the number of the electric discharge instruction lines 70 corresponds to the number of rows of picture elements. An electric discharge instruction signal Sh concerning the row is supplied to each of the electric discharge instruction lines 70, for example, by a vertical shift circuit 52. The light emission characteristic of the capacitive load 60 slightly differs as well.

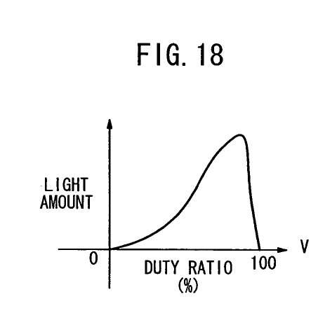

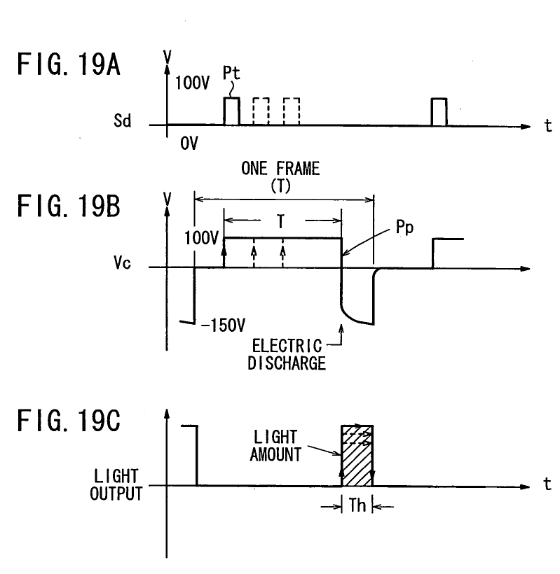

As shown in FIGS. 18 and 19B, the capacitive load 60 has a characteristic that the light amount is changed depending on the duty ratio {(τ/T)×100 (%)} of the output period τ of the first voltage state Pp with respect to a predetermined period (for example, one frame: T).

Therefore, the system based on the phase modulation can be easily applied for the gradation control. That is, the start time point of the first voltage state Pp is changed as shown in FIG. 19B by modulating the phase of the trigger signal Pt included in the picture element signal Sd depending on the gradation level of the picture element as shown in FIG. 19A. As for the light output waveform obtained in this procedure, as shown in FIG. 19C, the light output level during the electric discharge period Th of the capacitive load 60 is changed depending on the phase of the trigger signal Pt.

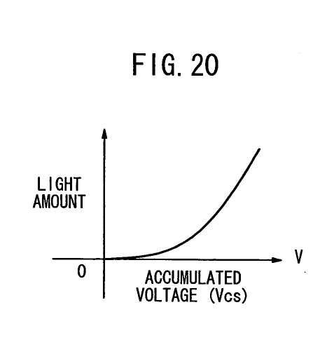

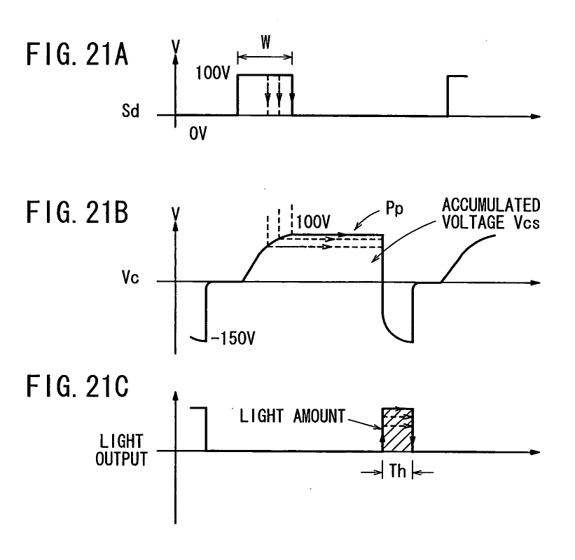

As shown in FIGS. 20 and 21B, it is also possible to use, as the capacitive load 60, a capacitive load having a characteristic that the light amount is changed depending on the accumulated voltage Vcs of the first voltage state Pp.

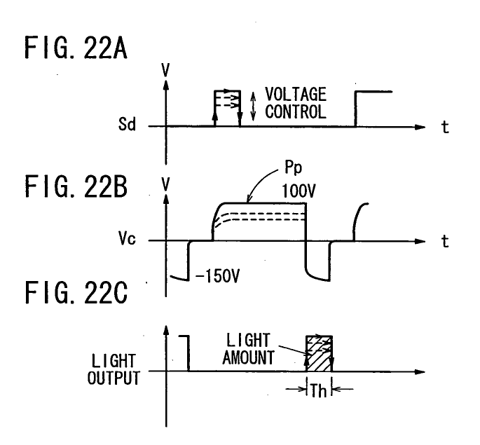

In this procedure, it is possible to adopt a system based on the pulse width modulation as shown in FIGS. 21A to 21C and a system based on the voltage control as shown in FIGS. 22A to 22C.

In the pulse width modulation system, the light emission luminance of the picture element is changed depending on the gradation level by changing the amplitude of the first voltage state Pp as shown in FIG. 21B by modulating the pulse width W of the picture element signal Sd depending on the gradation level of the picture element as shown in FIG. 21A. The light output waveform obtained in this procedure is shown in FIG. 21C. That is, the light output level during the electric discharge period Th of the capacitive load 60 is changed depending on the pulse width W of the picture element signal Sd.

In the voltage control system, the light emission luminance of the picture element is changed depending on the gradation level by changing the amplitude of the first voltage state Pp as shown in FIG. 22B by controlling the amplitude of the picture element signal Sd depending on the gradation level of the picture element as shown in FIG. 22A. The light output waveform obtained in this procedure is shown in FIG. 22C. That is, the light output level, which is outputted during the electric discharge period Th of the capacitive load 60, is changed depending on the amplitude of the picture element signal Sd.

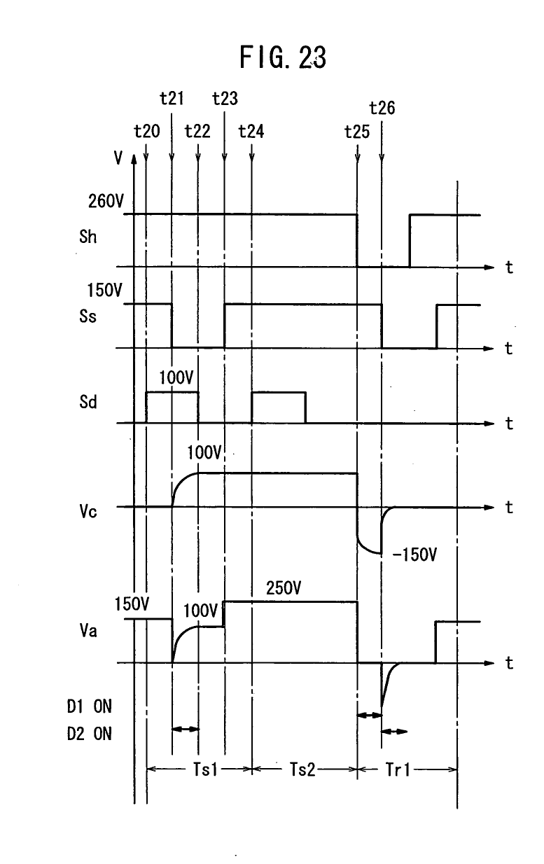

An explanation will now be made with reference to FIG. 23 about the driving system for the display device 40C as exemplified by the two-row scanning. FIG. 23 shows a timing chart in relation to the picture element disposed on the first row.

First, the system enters a selection period Ts1 for the picture element on the first row at a time point t20. In this situation, the electric discharge instruction signal Sh maintains the high level (for example, 260 V), the selection signal Ss maintains the high level (for example, 150 V), and the picture element signal Sd is changed to the high level (for example, 100 V). In this state, both of the first and second rectifying elements D1, D2 undergo the reverse bias as the non-conduction state. The electric potential Va at the connection point 58 is at the level of the selection signal Ss (150 V). The reference voltage (for example, 0 V) is maintained at both ends of the capacitive load 60.

When the selection signal Ss is changed to the low level (for example, 0 V), at the next time point t21, the first rectifying element D1 undergoes the forward bias as the conduction state, and the electric potential Va of the connection point 58 is steeply lowered from 150 V to 0 V. However, the charge of the capacitive load 60 is subsequently started, and the electric potential Va of the connection point 58 is gradually raised. The charge is continued until a time point t22 at which the picture element signal Sd is at the low level. For example, when 100 V is charged in the capacitive load 60 at the time point t22, the first rectifying element D1 undergoes the reverse bias again as the non-conduction state, and the electric potential Va of the connection point 58 is 100 V as well. The charged state is maintained until the electric discharge instruction signal Sh falls (until a time point t25).

When the selection signal Ss is changed to the high level (for example, 150 V) at the next time point t23, the electric potential Va of the connection point 58 rises up to 250 V. However, the terminal voltage Vc across the capacitive load 60 is not changed, because the electric discharge instruction signal Sh maintains the high level.

The system enters a selection period Ts2 for the picture element 42 on the second row from the next time point t24. However, in the selection period Ts2, the electric discharge instruction signal Sh for the first row maintains the high level. Therefore, even when the level of the picture element signal Sd is changed, the electric potential Va at the connection point 58 is not changed. Further, the levels are not as high as the high level of the electric discharge instruction signal Sh for the first row. Therefore, the reverse bias is applied to the first and second rectifying elements D1, D2 concerning the picture element 42 on the first row, and the non-conduction state is maintained.

Therefore, the picture element 42 on the first row is not affected by the picture element signal Sd for the picture element 42 on the second row. Further, the electric power, which is consumed by the capacitive load 60 in the unselection period, is approximately zero, and thus the electric power consumption is effectively reduced. Even when the picture element signal Sd for the first row remains to be 0 V, the electric potential Va of the connection point 58 is 150 V during the selection period Ts2 for the second row. The reverse bias is applied to the first and second rectifying elements D1, D2 of the picture element on the first row, and the non-conduction state is maintained.

The system enters an electric discharge period Th for the picture element 42 on the first row from a time point t25. When the electric discharge instruction signal Sh for the first row is changed to the low level (for example, 0 V), the first rectifying element D1 undergoes the forward bias as the conduction state. The electric potential Va of the connection point 58 is steeply lowered from 250 V to 0 V. Accordingly, the terminal voltage Vc across the capacitive load 60 is steeply lowered down to −150 V, simultaneously with which the light emission is effected by the capacitive load 60. The light emission is maintained until the selection signal Ss falls (until a time point t26).

When the selection signal Ss for the first row is changed to the low level (for example, 0 V) at the time point t26, then the second rectifying element D2 undergoes the forward bias as the conduction state, and the electric potential Va of the connection point 58 is steeply lowered from 0 V to −150 V. However, the charge of the capacitive load 60 is subsequently started. Therefore, the electric potential Va of the connection point 58 is gradually raised, and both of the electric potential Va of the connection point 58 and the terminal voltage Vc across the capacitive load 60 are 0 V.

When this driving system is applied, for example, to a case of the four-row scanning, it is possible to adopt the system shown in FIG. 13 or the system shown in FIG. 13B.

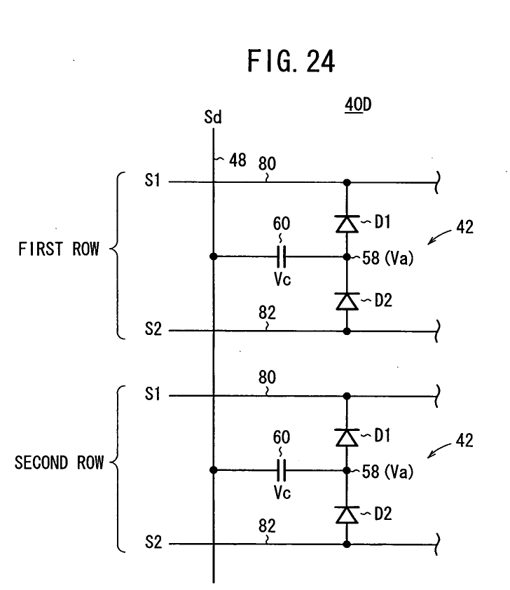

Next, a display device 40D according to a fourth embodiment will be explained with reference to FIG. 24.

The display device 40D according to the fourth embodiment is constructed in approximately the same manner as the display device 40B according to the second embodiment described above. However, the display device 40D is different from the display device 40B in the following points.

The picture element 42 includes first and second rectifying elements D1, D2 which are connected in series in the forward direction respectively between a first line 80 and a second line 82, and a capacitive load 60 which is connected between a signal line 48 and a connection point between the first and second rectifying elements D1, D2.

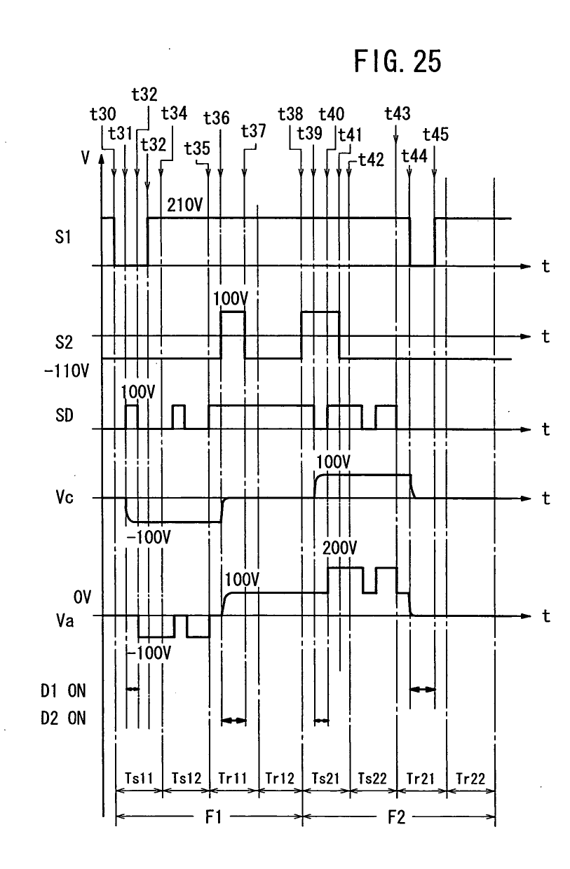

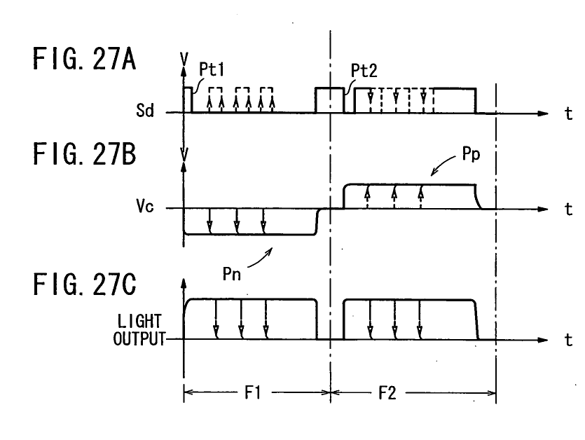

Further, as shown in FIGS. 25 and 27A to 27C, for example, one frame is divided into two fields (first and second fields F1, F2), and the control is made so that the picture element signal Sd is logically reversed in the first field F1 and the second field F2.

For example, as shown in FIGS. 27B and 27C, the control is made as follows. In the first field F1, the light emission is performed during the period in which the second voltage state Pn is applied to the capacitive load 60. In the second field F2, the light emission is performed in the period in which the first voltage state Pp is applied to the capacitive load 60.

Therefore, in the first field F1, the first line 80 functions as the select line, and the second line 82 functions as the reset line. On the contrary, in the second field F2, the first line 80 functions as the reset line, and the second line 82 functions as the select line. In view of this fact, the signal, which is transmitted through the first line 80, is referred to as “first signal S1”, and the signal, which is transmitted through the second line 82, is referred to as “second signal S2” in the following description.

The driving system for the display device 40D will now be explained with reference to FIG. 25 as exemplified by the two-row scanning. FIG. 25 shows a timing chart in relation to the picture element disposed on the first row.

First, the system enters the selection period Ts11 for the picture element on the first row in the first field F1 at a time point t30. In this situation, the first signal S1 is changed to the low level (for example, 0 V), the second signal S2 maintains the low level (for example, −110 V), and the picture element signal Sd maintains the low level (for example, 0 V). In this state, both of the rectifying elements D1, D2 undergo the reverse bias as the non-conduction state. The electric potential Va at the connection point 58 is at the level (0 V) of the picture element signal Sd. The state, in which 0 V is applied to both ends of the capacitive load 60, is maintained.

When the picture element signal Sd is changed to the high level (for example, 100 V) at the next time point t31, the first rectifying element D1 undergoes the forward bias as the conduction state. The terminal voltage Vc across the capacitive load 60 is steeply lowered down to −100 V, simultaneously with which the light emission is effected by the capacitive load 60. The light emission is maintained until the second signal S2 rises (until a time point t36).

When the picture element signal Sd is changed to the low level (0 V) at the next time point t32, the first rectifying element D1 undergoes the reverse bias again as the non-conduction state. The electric potential Va at the connection point 58 is the same as that of the terminal voltage Vc across the capacitive load 60, i.e., −100 V.

Subsequently, the first signal S1 is changed to be at the high level (for example, 210 V) at a time-point t33. This procedure is a preparatory process in order that the picture element 42 on the first row is not affected by the picture element signal Sd to be supplied to the picture element 42 on the second row in the next selection period Ts12 for the second row (unselection period for the first row).

The system enters the selection period Ts12 for the picture element on the second row (unselection period for the first row) from the next time point t34. However, in the selection period Ts12, the first signal S1 for the first row maintains the high level. Therefore, even when the level of the picture element signal Sd is changed and the electric potential Va of the connection point 58 is changed, the levels thereof are not as high as the high level of the first signal S1 for the first row. Therefore, the reverse bias is applied to the first and second rectifying elements D1, D2 in relation to the picture element 42 on the first row, and the non-conduction state is maintained.

Therefore, the picture element 42 on the first row is not affected by the picture element signal Sd for the picture element 42 on the second row. Further, the electric power, which is consumed by the capacitive load 60 in the unselection period, is approximately zero, which is effective to reduce the electric power consumption. Further, the capacitive load 60 continues to retain the electric charge during the unselection period. Therefore, it is possible to continue the light emission. Thus, it is possible to realize the high luminance and the high contrast.

The system enters the reset period Tr11 for the picture element 42 on the first row from a time point t35. When the picture element Sd is changed to the high level (for example, 100 V), the electric potential Va of the connection point 58 is raised up to 0 V. In this situation, the first signal S1 maintains the high level, and hence the terminal voltage Vc across the capacitive load 60 is not changed.

When the second signal S2 for the first row is changed to the high level (for example, 100 V) at the next time point t36, then the second rectifying element D2 undergoes the forward bias as the conduction state, and the electric potential Va of the connection point 58 is steeply raised from 0 V to 100 V. Accordingly, the terminal voltage Vc across the capacitive load 60 is steeply raised up to 0 V as the initial reset state.

When the second signal S2 for the first row is changed to the low level (for example, −110 V) at the next time point t37, the second rectifying element D2 undergoes the reverse bias again as the non-conduction state. The electric potential Va at the connection point 58 maintains 100 V, and the terminal voltage Vc across the capacitive load 60 is maintained to be 0 V as well.

After the reset period Tr12 for the next picture element 42 on the second row, the system enters the selection period Ts21 for the picture element 42 on the first row in the second field F2 at the next time point t38. In this situation, the first signal S1 maintains the high level (for example, 210 V), the second signal S2 is changed to the high level (for example, 100 V), and the picture element signal Sd maintains the high level (for example, 100 V). In this state, both of the first and second rectifying elements D1, D2 undergo the reverse bias as the non-conduction state. The electric potential Va at the connection point 58 is at the level of the picture element Sd (100 V). The state, in which 0 V is applied to both ends of the capacitive load 60, is maintained.

When the picture element signal Sd is changed to the low level (for example, 0 V) at the next time point t39, the second rectifying element D2 undergoes the forward bias as the conduction state. The terminal voltage Vc across the capacitive load 60 is steeply raised up to 100 V, simultaneously with which the light emission is effected by the capacitive load 60. The light emission is maintained until the first signal S1 rises (until a time point t44).

When the picture element signal Sd is changed to the high level (100 V) at the next time point t40, the second rectifying element D2 undergoes the reverse bias again as the non-conduction state. The electric potential Va at the connection point 58 is the same as the voltage obtained by adding the voltage of the picture element signal Sd to the terminal voltage Vc across the capacitive load 60, i.e., 200V.

The second signal S2 is changed to the low level (for example, −110 V) at the next time point t41.

The system enters the selection period Ts22 for the picture element on the second row (unselection period for the first row) from the next time point t42. However, in the selection period Ts22, the first signal S1 for the first row maintains the high level. Therefore, even when the level of the picture element signal Sd is changed and the electric potential Va of the connection point 58 is changed, the levels are not as high as the high level of the first signal S1. Therefore, the reverse bias is applied to the first and second rectifying elements D1, D2 in relation to the picture element 42 on the first row, and the non-conduction state is maintained.

Therefore, the picture element 42 on the first row is not affected by the picture element signal Sd for the picture element 42 on the second row.

The system enters the reset period Tr21 for the picture element 42 on the first row from a time point t43. When the picture element signal Sd is changed to the low level (for example, 0 V), the electric potential Va of the connection point 58 is lowered down to 100 V. In this situation, the first signal S1 maintains the high level. Therefore, the terminal voltage Vc across the capacitive load 60 is not changed.

When the first signal S1 for the first row is changed to the low level (for example, 0 V) at the next time point t44, the first rectifying element D1 undergoes the forward bias as the conduction state. The electric potential Va of the connection point 58 is steeply lowered from 100 V to 0 V. Accordingly, the terminal voltage Vc across the capacitive load 60 steeply drops down to 0 V as the initial reset state.

When the first signal S1 for the first row is changed to the high level (for example, 210 V) at the next time point t45, the first rectifying element D1 undergoes the reverse bias again as the non-conduction state. The electric potential Va at the connection point 58 maintains 0 V, and the terminal voltage Vc across the capacitive load 60 is maintained to be 0 V as well.

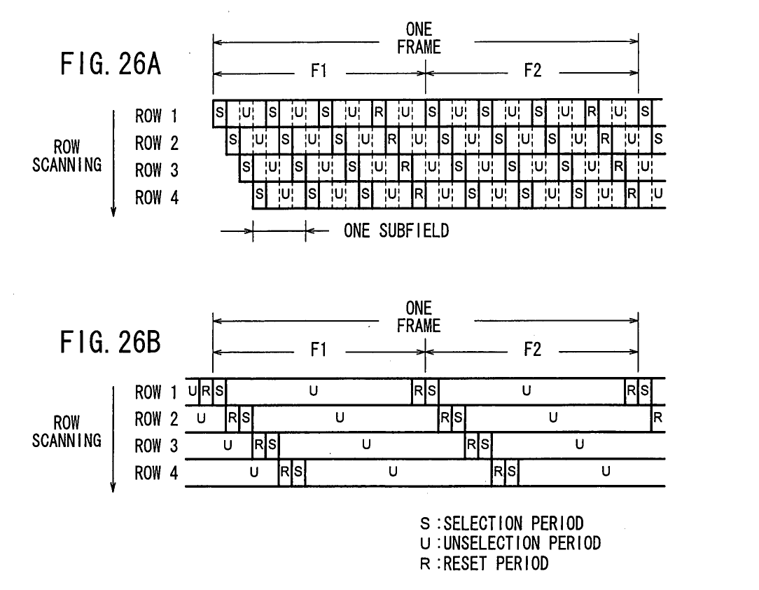

When this driving system is applied, for example, to the four-row scanning, it is possible to adopt a system as shown in FIG. 26A or a system as shown in FIG. 26B.

In the system shown in FIG. 26A, each of the first field F1 and the second field F2 is divided into four periods (subfields), and one subfield is divided into four periods. In the initial three subfields, the selection period is set for the initial period, and the unselection periods are set for the remaining three fields for each of the subfields. As for the remaining subfield, the reset period is set for the initial period, and the unselection periods are set for the remaining three periods. In the second field F2, the same setting as described above is made. This system is preferably usable for the time gradation control.

On the other hand, in the system shown in FIG. 26B, each of the first field F1 and the second field F2 is divided into eight or more periods. For example, in the first field F1, the selection period is set for the first period, the reset period is set for the final period of each frame, and the unselection periods are set for the remaining periods. In the second field F2, the same setting as described above is made. According to this system, it is possible to remove any light off period in the unselection period after the reset period, and it is possible to obtain an effect to improve the luminance.

The system shown in FIG. 26A may be combined with the system shown in FIG. 26B.

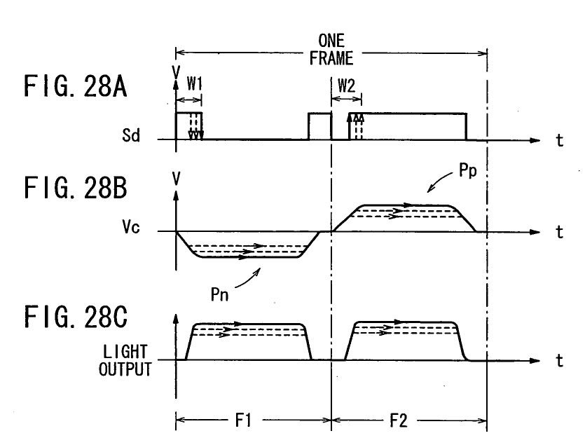

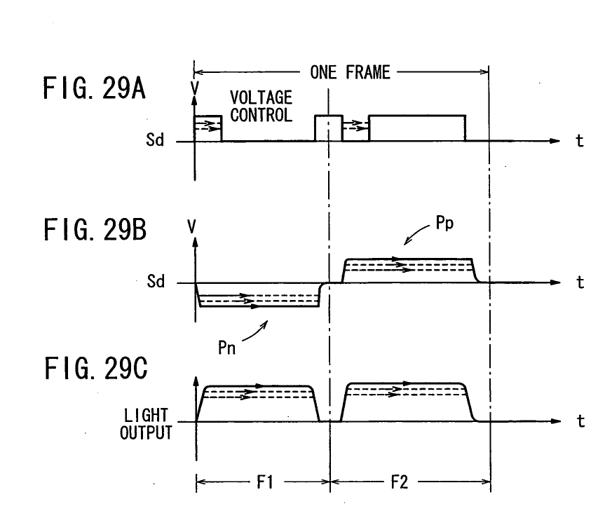

The gradation control for the picture element includes a system based on the phase modulation as shown in FIGS. 27A to 27C (time gradation control), a system based on the pulse width modulation as shown in FIGS. 28A to 28C, and a system based on the voltage control as shown in FIGS. 29A to 29C.

In the system based on the phase modulation, the start time points of the second voltage state Pn and the first voltage state Pp are changed as shown in FIG. 27B by modulating the phases of the trigger signal Pt1 having positive polarity and the trigger signal Pt2 having negative polarity included in the picture element signal Sd depending on the gradation level of the picture element as shown in FIG. 27A. As for the light output waveform obtained in this procedure, as shown in FIG. 27C, the light output period is changed depending on the phases of the trigger signals Pt1, Pt2.

In the pulse width modulation system, the light emission luminance of the picture element is changed depending on the gradation level by changing the amplitudes of the second voltage state Pn and the first voltage state Pp as shown in FIG. 28B by modulating the pulse widths W1, W1 of the picture element signal Sd depending on the gradation level of the picture element as shown in FIG. 28A. As for the light output waveform obtained in this procedure, as shown in FIG. 28C, the light output level is changed depending on the pulse width.

In the voltage control system, the light emission luminance of the picture element 42 is changed depending on the gradation level by changing the amplitudes of the second voltage state Pn and the first voltage state Pp as shown in FIG. 29B by controlling the amplitude of the picture element signal Sd depending on the gradation level of the picture element as shown in FIG. 29A. As for the light output waveform obtained in this procedure, as shown in FIG. 29C, the light output level is changed depending on the amplitude of the picture element signal Sd.

In the voltage control system, arbitrary gradations can be expressed as follows. Assuming that the ON level of the picture element signal Sd is, for example, 80 V and the OFF level is 0 V in the first field F1, the logical reversal may be made in the second field F2 so that the ON level of the picture element signal Sd is, for example, 20 V and the OFF level is 100 V in the second field F2.

In particular, in the display device 40D according to the fourth embodiment, when the second voltage state Pn is applied to the capacitive load 60 to emit the light in the first field F1, the light emission is maintained until the second signal S2 is at the high level. Further, when the first voltage state Pp is applied to the capacitive load 60 to emit the light in the second field F2, the light emission is maintained until the first signal S1 becomes the low level. That is, it is possible to provide the memory effect in the two fields F1, F2.

Therefore, the display device 40D is more advantageous to realize the high luminance. Even when the light emission is changed depending on the effective value of the voltage, it is possible to obtain a large dynamic range for the effective value. Thus, it is possible to further realize the high luminance and the high contrast. Further, liquid crystal cells can be preferably adopted as the capacitive loads. By the liquid crystal cells, it is sufficient to use a small voltage in order to obtain an identical effective value. Therefore, it is possible to realize the operation at a low voltage. That is, in the matrix driving, a predetermined voltage is progressively applied to each of the picture elements while performing the row scanning. However, in order to obtain a predetermined effective value in the selection period for the row to which the picture element is connected, it is necessary to use a high voltage as the voltage to be applied to the picture element. On the contrary, in the case of the display devices 40A to 40D according to the first to fourth embodiments, the voltage is continuously retained not only in the selection period of the row but also in the time period in which the picture element is in the unselected state. Therefore, it is sufficient to use a small applied voltage (absolute value) in order to obtain an identical effective value.

The absolute value of the voltage and the pulse width can be identical between the first voltage and the second voltage as described above. Alternatively, it is also easy to make the voltages and the pulse widths different. That is, the picture element signal Sd is controlled so as to be logically reversed in the first field F1 and the second field F2. Otherwise, the picture element signal Sd for the first field F1 may be controlled independently of the picture element signal Sd for the second field F2.

In the display device 40B according to the second embodiment and the display device 40D according to the fourth embodiment described above, a resistor may be connected in parallel to the capacitive load 60, and the electric charge, which is charged in the capacitive load 60 during the selection, may be discharged during the unselection by the resistor.

In this procedure, an appropriate time constant may be set for the capacitive load 60 and the resistor to effectively utilize the electric discharge time. For example, in the case of the liquid crystal display device, the voltage is returned to zero by the electric discharge during the unselection period, and the light transmittance is returned to the original value. However, in the case of the example described above, the time average value of the light transmittance can be controlled by using the voltage to be charged during the selection period (or by using the number of times of charge to be performed during the selection period). Therefore, it is possible to perform the gradational expression. Further, this procedure is advantageous in that the electric charge charged in the capacitive load 60 can be returned to zero without providing the reset period.

For example, when the displacement is controlled by using a piezoelectric material, the voltage-displacement characteristic has hysteresis. Therefore, the procedure is also effective, for example, for a case in which the displacement is retained even when the voltage is returned to zero when the displacement is generated by applying the voltage. Further, for example, the procedure is also effective for a case of the liquid crystal display device in which the lowered light transmittance state is retained even when the voltage is returned to zero when the light transmittance is lowered by applying the voltage.

In the display devices 40A to 40D according to the first to fourth embodiments, the voltage can be applied alternately to the picture element. This procedure is used effectively when it is intended to exclude any DC component from the applied voltage for the picture element irrelevant to the image pattern. This procedure is used especially preferably for the display element which utilizes the AC driving system. This procedure is especially preferred for the liquid crystal display element and the electroluminescence display element.

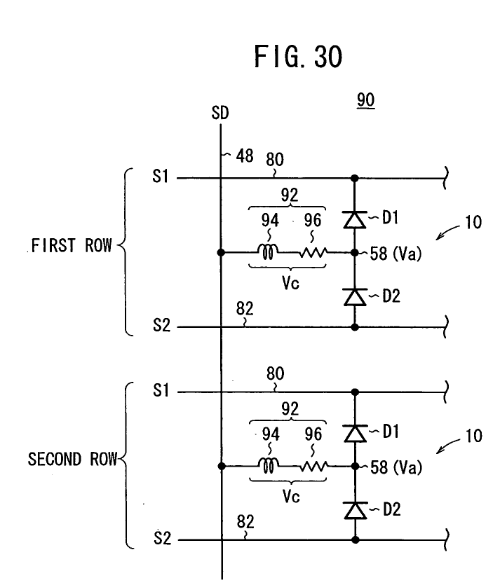

Next, an explanation will be made with reference to FIGS. 30 to 35B about an illustrative embodiment in which the circuit element 10 and the signal processing circuit 30 according to the embodiments of the present invention are applied to a device of the position control system.

As shown in FIG. 30, a circuit element 10 of a position control device 90 according to this embodiment includes first and second rectifying elements D1, D2 which are connected in series in the forward direction between a first line 80 and a second line 82, and a load 92 which is connected between a signal line 48 and a connection point 58 between the first and second rectifying elements D1, D2. The load 92 comprises an inductor 94 and a resistor 96 which are connected in series.

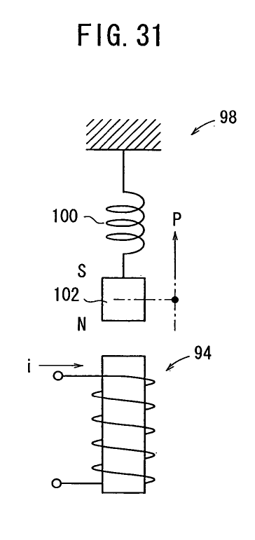

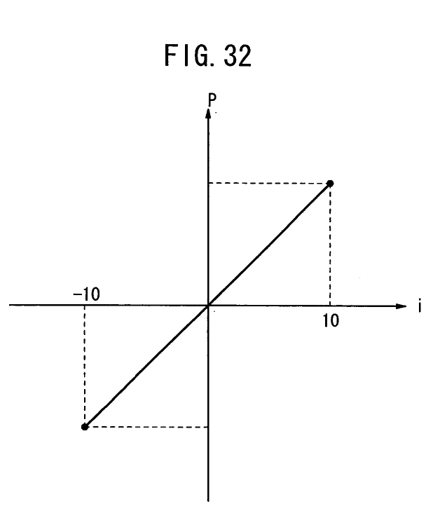

FIG. 31 shows a model 98 of a position control system constructed by the inductor 94 and the resistor 96. This model shows that a control objective 102, which is connected to the ceiling via a spring 100, has the position P which is controlled by the magnetic field generated by the current i flowing through the inductor 94. That is, as shown in FIG. 32, the position P can be changed in the positive direction (upward direction) and the negative direction (downward direction) depending on the magnitude and the direction of the current i flowing through the inductor 94. In other words, the inductor 94 controls the displacement of the control objective.

The current i flowing through the inductor is determined by the resistor R and the terminal voltage Vc across the load 92. The voltage Vc=Ri except for the transient state.

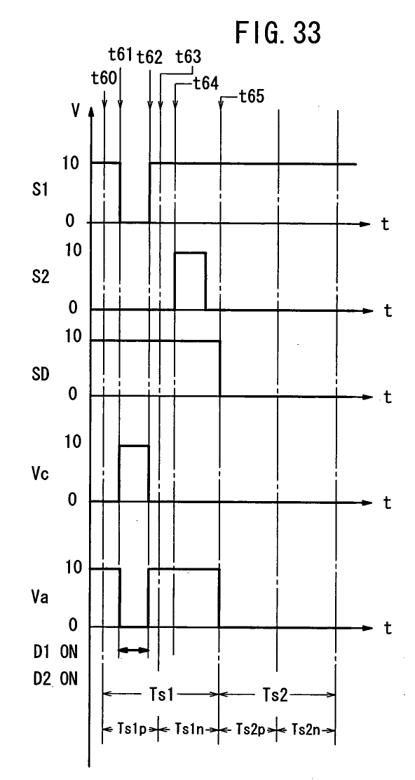

As for the position control device 90, as shown in FIG. 33, for example, the control is made as follows. The selection period Ts1 for the circuit element 10 on the first row is divided into two periods (positive direction period Ts1p and negative direction period Ts1n). When the control objective 102 is moved in the positive direction, the control objective 102 is driven in the positive direction period Ts1p. When the control objective 102 is moved in the negative direction, the control objective 102 is driven in the negative direction period Ts1n.

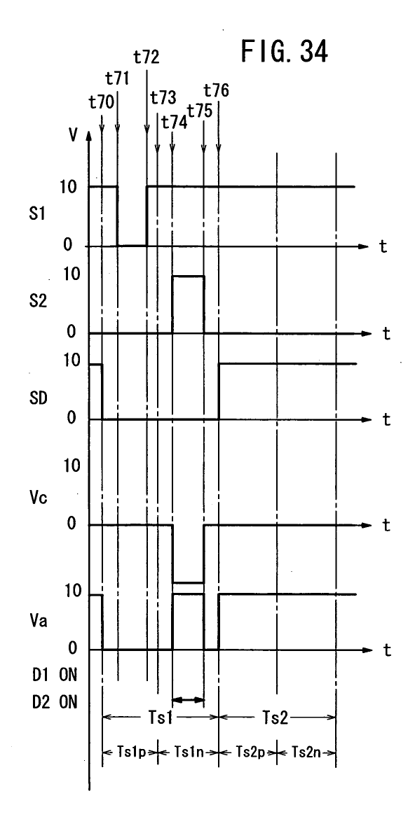

The driving system for the position control device 90 will now be explained with reference to FIGS. 33 and 34 as exemplified by the two-row scanning. The waveforms shown in FIGS. 33 and 34 are illustrative of timing charts in relation to the circuit element 10 disposed on the first row. In particular, FIG. 33 shows a timing chart adopted when the control objective is driven and displaced in the positive direction, and FIG. 34 shows a timing chart adopted when the control objective is driven and displaced in the negative direction.

First, the system enters the positive direction period Ts1p in the selection period Ts1 for the circuit element 10 on the first row at a time point t60 shown in FIG. 33. In this situation, the first signal S1 maintains the high level (for example, 10 V), the second signal S2 maintains the low level (for example, 0 V), and the data signal SD maintains the high level (for example, 10 V). In this state, both of the first and second rectifying elements D1, D2 undergo the reverse bias as the non-conduction state. The electric potential Va at the connection point 58 is the same as the level (10 V) of the data signal SD. As a result, 0 V is maintained as the voltage Vc across the load 92.

When the first signal S1 is changed to the low level (for example, 0 V) at the next time point t61, the first rectifying element D1 undergoes the forward bias as the conduction state. The electric potential Va of the connection point 58 steeply drops down to 0 V, simultaneously with which the terminal voltage Vc across the load 92 is steeply raised up to the high level (for example, 10 V). Thus, the current flows through the inductor 94 in the positive direction, and the control objective 102 is moved in the positive direction.

When the first signal S1 is changed to the high level (for example, 10 V) at the next time point t62, the first rectifying element D1 undergoes the reverse bias again as the non-conduction state. The electric potential Va of the connection point 58 is steeply raised up to 10 V, simultaneously with which the terminal voltage Vc across the load 92 steeply drops down to the low level (for example, 0 V). Thus, the control objective 102 is moved toward the original position (zero point).

The system enters the negative direction period Ts1n for the circuit element 10 on the first row at the next time point t63. In the period Ts1n, the data signal SD maintains the high level (for example, 10 V). Therefore, even when the second signal S2 is changed to the high level (for example 10 V) at a time point t64 thereafter, both of the first and second rectifying elements D1, D2 remain in the non-conduction state. 0 V is maintained as the voltage Vc across the load 92. That is, the control objective 102 remains to stop at the zero point.

The system enters the selection period Ts2 for the circuit element 10 on the second row (unselection period for the first row) at the next time point t65. However, in the selection period Ts2, the first signal S1 for the first row maintains the high level. Therefore, even when the level of the data signal SD is changed, and the electric potential Va of the connection point 58 is changed, then the levels thereof are not as high as the high level of the first signal S1 for the first row. Therefore, the non-conduction state is maintained for both of the first and second rectifying elements D1, D2 in relation to the circuit element 10 on the first row.

Therefore, the circuit element 10 on the first row is not affected by the data signal SD for the circuit element 10 on the second row. Further, the current i, flowing into the load 92 in the unselection period, is approximately zero. It is possible to decrease the electric power consumption as well.

Next, the displacement in the negative direction is controlled as follows. First, the system enters the selection period Ts1 for the circuit element 10 on the first row at a time point t70 shown in FIG. 34. At this time point t70, the first signal S1 maintains the high level (for example, 10 V), the second signal S2 maintains the low level (for example, 0 V), and the data signal SD is changed to the low level (for example, 0 V). In this situation, both of the first and second rectifying elements D1, D2 are in the non-conduction state. Therefore, the electric potential Va at the connection point steeply drops down to 0 V. As a result, 0 V is maintained as the voltage Vc across the load 92.

Even when the first signal S1 is changed to the low level (for example, 0 V) at the next time point t71, the electric potential Va of the connection point is still maintained at 0 V. Therefore, 0 V is maintained as the voltage Vc across the load 92.

When the first signal S1 is changed to the high level at the next time point t72, the first rectifying element D1 undergoes the reverse bias as the non-conduction state. The electric potential Va of the connection point is still maintained at 0 V, and 0 V is maintained as the voltage Vc across the load 92.

The system enters the negative direction period Ts1n for the circuit element 10 on the first row at the next time point t73. When the second signal S2 is changed to the high level (for example 10 V) at a subsequent time point t74, the second rectifying element D2 is in the conduction state, and the electric potential Va of the connection point 58 is steeply raised up to 10 V, simultaneously with which the voltage Vc across the load 92 steeply drops down to the low level (for example, −10 V). Accordingly, the current flows through the inductor 94 in the negative direction, and the control objective 102 is moved in the negative direction.

When the second signal S2 is changed to the low level (for example, 0 V) at the next time point t75, the second rectifying element D2 undergoes the reverse bias again as the non-conduction state. The electric potential Va of the connection point 58 steeply drops down to 0 V, simultaneously with which the terminal voltage Vc across the load 92 is steeply raised up to the high level (for example, 0 V). The control objective 102 is moved toward the original position (zero point).

The system enters the selection period Ts2 for the circuit element 10 on the second row (unselection period for the first row) at the next time point t76. However, in the selection period Ts2, the first signal S1 for the first row maintains the high level. Therefore, even when the level of the data signal SD is changed and the electric potential Va of the connection point 58 is changed, the levels thereof are not as high as the high level of the first signal S1 for the first row. Therefore, the non-conduction state is maintained for both of the first and second rectifying elements D1, D2 in relation to the circuit element 10 on the first row.

Therefore, the circuit element 10 on the first row is not affected by the data signal SD for the circuit element 10 on the second row. Further, the current i which flows into the load 92 in the unselection period is approximately zero. It is possible to decrease the electric power consumption as well.

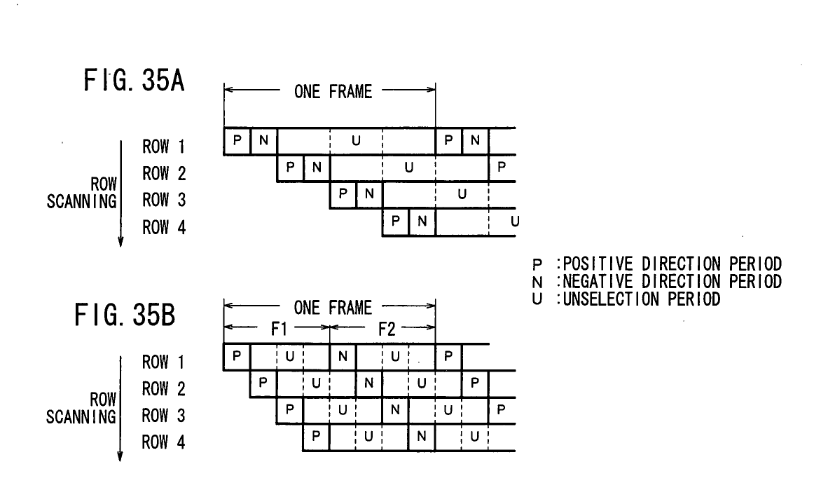

When the driving system is applied, for example, to a case of the four-row scanning, it is possible to adopt a system as shown in FIG. 35A or a system as shown in FIG. 35B.

In the system shown in FIG. 35A, it is assumed that the period, in which all position control is completed for the circuit elements 10 on the four rows, is designated as one frame. On this assumption, the one frame is divided into four periods. Further, the positive direction period and the negative direction period are set in the first period, and the unselection period is set in the remaining three periods.

On the other hand, in the system shown in FIG. 35B, one frame is divided into two periods (first and second fields F1, F2). Further, each of the first and second fields F1, F2 is divided into four periods. As for the first field F1, the positive direction period is set in the first period, and the unselection period is set in the remaining three periods. As for the second field F2, the negative direction period is set in the first period, and the unselection period is set in the remaining three periods.

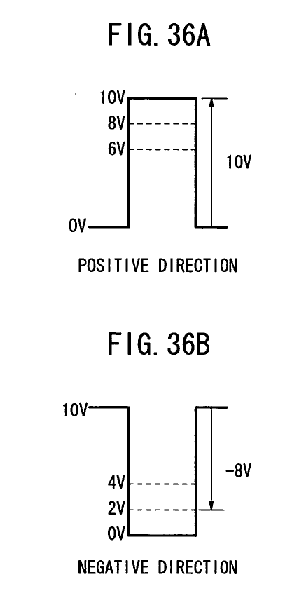

A system based on the voltage control is preferably adopted for the position control for the control objective 102. For example, when the control objective 102 is moved in the positive direction to a position corresponding to a terminal voltage Vc across the load 92 with 10 V, the level of the first signal S1 is set to 0 V, and the level of the data signal SD is set to 10 V in the positive direction period. Accordingly, as shown in FIG. 36A, the terminal voltage Vc across the load 92 can be 10 V in the positive direction.

On the other hand, when the control objective 102 is moved in the negative direction to a position corresponding to a terminal voltage Vc across the load 92 with 8 V, then the level of the second signal S2 is set to 10 V, and the level of the data signal SD is set to 2 V in the negative direction period. Accordingly, as shown in FIG. 36B, the terminal voltage Vc across the load 92 can be made to be 8 V in the negative direction (i.e., −8 V).

The embodiment described above is the case in which the current-position characteristic is subjected to the change linearly as shown in FIG. 32. Alternatively, a hysteresis curve may be depicted on the basis of the current i=0. For example, a magnetized coil has some residual magnetization even when the current is returned to zero. In this case, when the unselection period is given and the current is zero after the movement to a predetermined position with the current flowing during the selection period, it is possible to approximately retain the predetermined position by the residual magnetization.

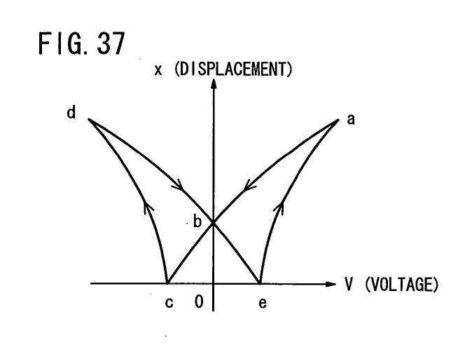

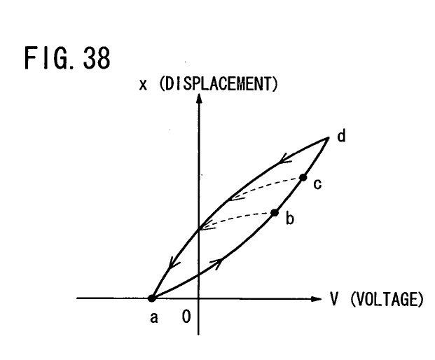

Next, for example, an element, which has a characteristic equivalent to the displacement-voltage characteristic of the piezoelectric element as shown, for example, in FIG. 37 or FIG. 38, can be used, for example, as the displacement control element for the capacitive load to perform the displacement control and the position control.

In the piezoelectric element having the displacement-voltage characteristic as shown in FIG. 37, an approximately linear voltage-displacement characteristic can be obtained, for example, by utilizing a portion depicted by a segment connecting Point “a” and Point “c” or by utilizing a portion depicted by a segment connecting Point “d” and Point “e”. Thus, the control can be made with ease. On the other hand, in the piezoelectric element having the displacement-voltage characteristic as shown in FIG. 38, the change of the displacement amount of expansion with respect to the change of the voltage is different from the change of the displacement amount of the contraction or shrinkage with respect to the change of the voltage, in which the hysteresis is provided in relation to the voltage-displacement characteristic. Therefore, such a piezoelectric element is advantageous, for example, when the cam operation is performed.

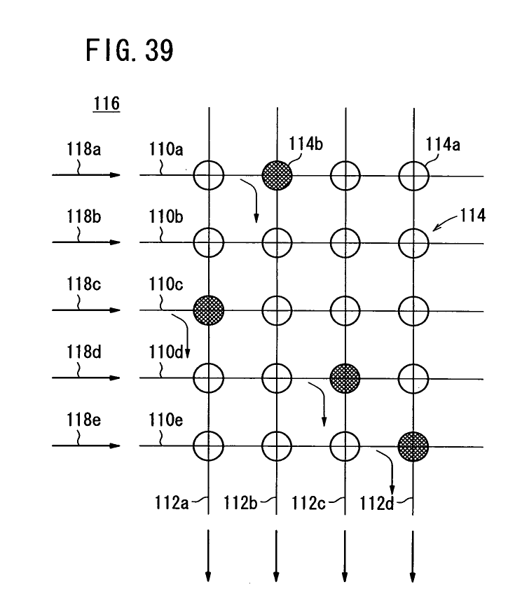

In FIG. 39, a device is exemplified, which uses the displacement control element having a characteristic equivalent to the displacement-voltage characteristic of the piezoelectric element as shown in FIG. 37 or FIG. 38. The device is an optical switch array 116 in which a plurality of optical waveguide paths 110a to 110e are aligned in the vertical direction, a plurality of optical waveguide paths 112a to 112d are aligned in the horizontal direction, and optical switches 114 are arranged at respective intersections. In the optical switch array 116, light beams 118a to 118e come into the plurality of optical waveguide paths 110a to 110e aligned in the vertical direction, and some of the light beams outgo from the optical waveguide paths 112a to 112d aligned in the horizontal direction. In FIG. 39, the light beam 118a coming into the optical waveguide path 110a on the first row outgoes from the optical waveguide path 112b on the second column; the light beam 118b coming into the optical waveguide path 110b on the second row outgoes as it is in the horizontal direction; the light beam 118c coming into the optical waveguide path 110c on the third row outgoes from the optical waveguide path 112a on the first column; the light beam 118d coming into the optical waveguide path 110d on the fourth row outgoes from the optical waveguide path 112c on the third column; and the light beam 118e coming into the optical waveguide path 110e on the fifth row outgoes from the optical waveguide path 112d on the fourth column. In FIG. 39, open circles show that the optical switch 114 is in the first state (114a) to guide the incident light in the horizontal direction, and filled circles show that the optical switch 114 is in the second state (114b) to guide the incident light in the vertical direction.

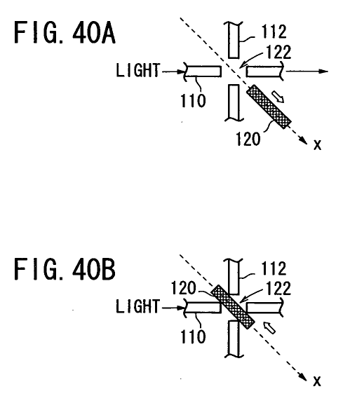

In order to realize the first state (114a), as shown in FIG. 40A, a reflection plate 120 connected to the displacement control element (not shown) is prevented from being inserted into an intersection 122 between the optical waveguide path 110 extending in the row direction and the optical waveguide path 112 extending in the column direction. In order to realize the second state (114b), as shown in FIG. 40B, the reflection plate 120 connected to the displacement control element is inserted into the intersection 122.

A method of driving the displacement control element can be easily realized in accordance with a driving method similar to the methods for the display devices 40A to 40D according to the first to fourth embodiments described above.

Other than the piezoelectric material as described above, another method may be used in order to control the displacement. For example, a pair of electrodes are opposed to one another to change the distance between the electrodes by means of the electrostatic force exerted when a voltage is applied between the electrodes.

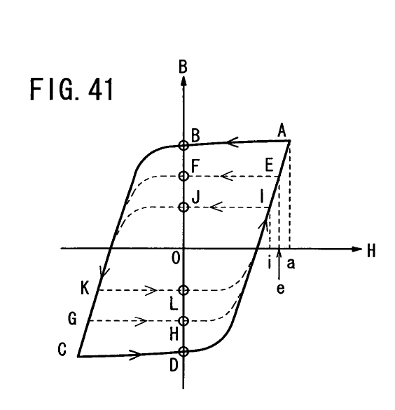

Next, as shown in FIG. 41, an explanation will be made about a method of driving the displacement control element based on the use of a coil having a B-H characteristic in which the residual magnetic flux is large (hysteresis is large). The phrase “magnetic flux is large” indicates the fact that the B-H curve has a hysteresis, and the saturation magnetic flux density is approximately the same as the residual magnetic flux density. The circuit configuration of a position control device having the displacement control element as described above is constructed in approximately the same manner as the configuration shown in FIG. 30.

First, in relation to the B-H curve shown in FIG. 41, the magnetic field (H) corresponds to the current i flowing through the coil, and the magnetic flux density (B) corresponds to the displacement amount of the control objective. Therefore, for example, when it is intended to obtain a residual magnetic flux density indicated by Point F, the voltage level is set so that a current corresponding to Point “e” flows in the selection period. In this situation, the operation point of the displacement control element is moved to Point E. When the current is shut off in the unselection period, the operation point is moved to Point F. That is, the control objective is displaced to a position corresponding to the residual magnetic flux density indicated by Point F.

The driving voltage may be applied to the displacement control element alternately, for example, such that Point F and Point H each having a reversed polarity are used as a pair. Alternatively, a driving voltage having different positive and negative voltage levels may be applied to make the control, for example, such that the negative polarity side is in the reset state to always pass through Point D while passing through Point B, Point F, or Point J on the positive polarity side.

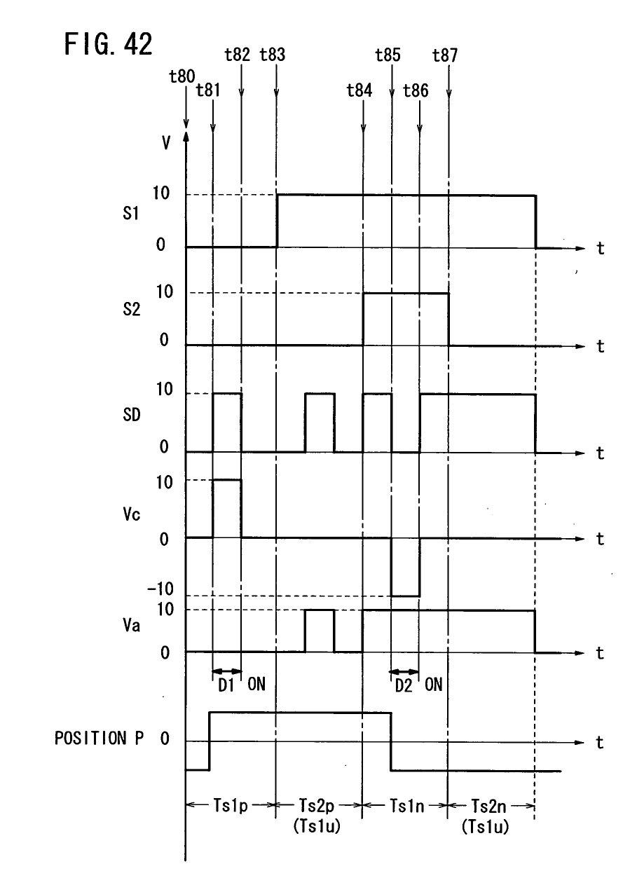

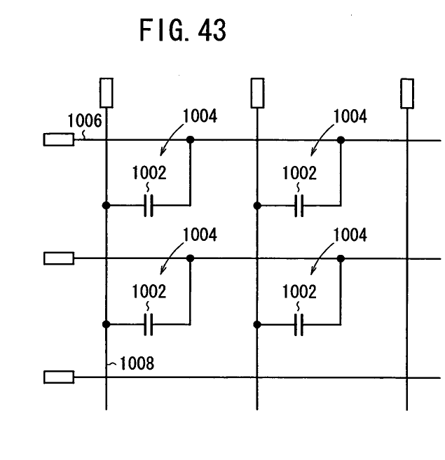

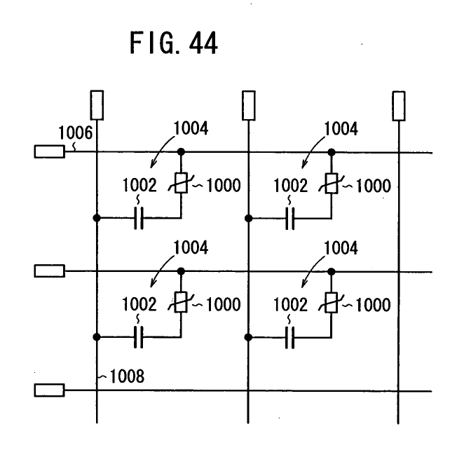

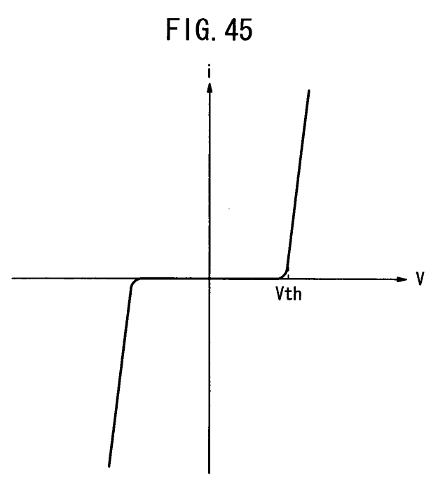

An explanation will now be made with reference to FIG. 42 about an example of the method of driving the circuit element 10 including the displacement control element based on the use of the coil having the B-H characteristic as shown in FIG. 41.

In this driving method, as shown in FIG. 42, for example, the positive direction period Ts1p begins, which is the selection period for the circuit element 10 on the first row. After that, for example, the positive direction period Ts2p (unselection period Ts1u for the circuit element on the first row) follows, which is the selection period for the circuit element 10 on the second row. After that, the negative direction period Ts1n follows, which is the selection period for the circuit element 10 on the first row. After that, for example, the negative direction period Ts2n (unselection period Ts1u for the circuit element 10 on the first row) follows, which is the selection period for the circuit element on the second row.

First, the system enters the positive direction period Ts1p for the circuit element 10 on the first row at a time point t80 shown in FIG. 42. In this situation, the first signal S1 maintains the low level (for example, 0 V), the second signal S2 also maintains the low level (for example, 0 V), and the data signal SD also maintains the low level (for example, 0 V). In this state, both of the first and second rectifying elements D1, D2 are in the non-conduction state. As shown in FIG. 30, the electric potential Va at the connection point 58 is at the same level as the level (0 V) of the data signal SD. As a result, 0 V is maintained as the voltage across the load 92.

When the data signal SD is changed to the high level (for example, 10 V) at the next time point t81, the first rectifying element D1 undergoes the forward bias as the conduction state, and the voltage Vc across the load 92 is steeply raised up to the high level (for example, 10 V). Accordingly, the current flow through the inductor 94 in the positive direction, and the control objective 102 is moved in the positive direction. For example, the control objective 102 is moved to the position in the positive direction corresponding to the magnetic flux density indicated by Point A shown in FIG. 41. In this situation, the electric potential Va of the connection point maintains 0 V.

When the data signal SD is changed to the low level (for example, 0 V) at the next time point t82, the first rectifying element D1 undergoes the reverse bias again as the non-conduction state, and the voltage Vc across the load 92 steeply drops down to the low level (for example, 0 V). However, the control objective stops at the position corresponding to the residual magnetic flux density indicated by Point B shown in FIG. 41.

The system enters the positive direction period Ts2p for the circuit element 10 on the second row (unselection period Ts1u for the circuit element on the first row) at the next time point t83. In this situation, the first signal S1 is changed to be at the high level (for example, 10 V). Therefore, in the positive direction period Ts2p, even when the level of the data signal SD is changed and the electric potential Va of the connection point 58 is changed, the levels thereof are not as high as the high level of the first signal S1 for the first row and not as low as the low level of the second signal S2 for the first row. Therefore, the non-conduction state is maintained for both of the first and second rectifying elements D1, D2 in relation to the circuit element 10 on the first row. In other words, the control objective 102 stops at the position corresponding to the residual magnetic flux density indicated by Point B shown in FIG. 41.

The system enters the negative direction period Ts1n for the circuit element 10 on the first row at the next time point t84. In this situation, the first signal S1 maintains the high level, the second signal S2 is changed to the high level (for example, 10 V), and the data signal SD is changed to the high level (for example, 10 V). In this case, the electric potential Va at the connection point 58 is at the same level as the level (10 V) of the data signal SD. The non-conduction state is maintained for both of the first and second rectifying elements D1, D2 in relation to the circuit element 10 on the first row. In other words, the control objective stops at the position corresponding to the residual magnetic flux density indicated by Point B shown in FIG. 41.

When the data signal SD is changed to the low level (for example, 0 V) at the next time point t85, the second rectifying element D2 undergoes the forward bias as the conduction state, and the voltage Vc across the load 92 is steeply lowered down to the low level (for example, −10 V). Accordingly, the current flows through the inductor 94 in the negative direction, and the control objective 102 is moved in the negative direction. For example, the control objective 102 is moved to the position in the negative direction corresponding to the magnetic flux density indicated by Point C shown in FIG. 41. In this situation, the electric potential Va of the connection point maintains 10 V.

When the data signal SD is changed to the high level (for example, 10 V) at the next time point t86, the second rectifying element D2 undergoes the reverse bias again as the non-conduction state, and the voltage Vc across the load 92 is steeply raised up to 0 V. However, the control objective stops at the position corresponding to the residual magnetic flux density indicated by Point D shown in FIG. 41.

The system enters the negative direction period Ts2n for the circuit element 10 on the second row (unselection period Ts1u for the circuit element on the first row) at the next time point t87. In this situation, the second signal S2 is changed to the low level (for example, 0 V). Therefore, in the negative direction period Ts2n, even when the level of the data signal SD is changed, the level is not as high as the high level of the first signal S1 for the first row and not as low as the low level of the second signal S2 for the first row. Therefore, the non-conduction state is maintained for both of the first and second rectifying elements D1, D2 in relation to the circuit element 10 on the first row. In other words, the control objective stops at the position corresponding to the residual magnetic flux density indicated by Point D shown in FIG. 41.

As described above, the circuit element 10 on the first row is not affected by the data signal SD for the circuit element 10 on the second row. Further, the position of the control objective can be maintained by utilizing the residual magnetic flux density of the B-H characteristic shown in FIG. 41. In other words, no current flows through the inductor 94 in the unselection period. Therefore, the position of the control objective 102 is retained by the residual magnetization without any change. The current i, which flows into the load 92, is approximately zero in the unselection period. Thus, it is possible to decrease the electric power consumption as well.

It is a matter of course that the circuit element, the signal processing circuit, the control device, the display device, the method of driving the display device, the method of driving the circuit element, and the method of driving the control device according to the present invention are not limited to the embodiments described above, which may be embodied in other various forms without deviating from the gist or essential characteristics of the present invention.

What is claimed is:

1. A circuit element comprising:
a first lead wire;
a second lead wire;
a third lead wire;
a first rectifying element and a second rectifying element which are connected in series in a forward direction between said first lead wire and said second lead wire; and
a load which is connected between said third lead wire and a connection point between said first rectifying element and said second rectifying element.

2. The circuit element according to claim 1, wherein V1≧V2 over an entire operating period provided that V1 represents an electric potential of said first lead wire and V2 represents an electric potential of said second lead wire.

3. The circuit element according to claim 2, wherein in said operating period, a first period is set in which a current flows from said third lead wire to said load.

4. The circuit element according to claim 3, wherein V1<V3 in said first period provided that V3 represents an electric potential of said connection point.

5. The circuit element according to claim 2, wherein in said operating period, a second period is set in which a current flows from said second lead wire to said load.

6. The circuit element according to claim 5, wherein V2>V3 in said second period provided that V3 represents an electric potential of said connection point.

7. The circuit element according to claim 2, wherein in said operating period, a third period is set in which a current does not flow in said load.

8. The circuit element according to claim 7, wherein V2≦V3≦V1 in said third period provided that V3 represents an electric potential of said connection point.

9. The circuit element according to claim 1, wherein said rectifying element is a diode.

10. The circuit element according to claim 9, wherein said diode is a thin film diode.

11. The circuit element according to claim 10, wherein said thin film diode is an MIM element.

12. A signal processing circuit comprising a circuit element and a control circuit,
wherein said circuit element includes:
a first lead wire;
a second lead wire;
a third lead wire;
a first rectifying element and a second rectifying element which are connected in series in a forward direction between said first lead wire and said second lead wire; and
a load which is connected between said third lead wire and a connection point between said first rectifying element and said second rectifying element;
said control circuit controls at least an electric potential of said first lead wire and an electric potential of said second lead wire.

13. A control device comprising a plurality of circuit elements and a plurality of control circuits,
wherein each of said circuit elements includes:
a first lead wire;
a second lead wire;
a third lead wire;
a first rectifying element and a second rectifying element which are connected in series in a forward direction between said first lead wire and said second lead wire; and
a load which is connected between said third lead wire and a connection point between said first rectifying element and said second rectifying element;
each of said control circuits controls electric potentials of said first lead wire, said second lead wire, and said third lead wire.

14. The control device according to claim 13, wherein V1≧V2 over an entire operating period provided that V1 represents said electric potential of said first lead wire and V2 represents said electric potential of said second lead wire.

15. The control device according to claim 14, wherein a selection period and an unselection period are set for each of said circuit elements in said operating period; and
V2≦V3≦V1 in said unselection period provided that V3 represents an electric potential of said connection point.

16. The control device according to claim 15, wherein V1<V3 or V2>V3 while each of said circuit elements is actually selected in said selection period.

17. The control device according to claim 16, wherein a reset period is set for each of said circuit elements in said operating period; and
V1<V3 or V2>V3 while each of said circuit elements is actually reset in said reset period.

18. The control device according to claim 13, wherein said load is a displacement control element which displaces a control objective based on a voltage applied to said load.

19. The control device according to claim 18, wherein said displacement control element includes a piezoelectric element.

20. The control device according to claim 18, wherein said displacement control element includes an inductor, and a displacement of said control objective is controlled by magnetization of said inductor which is controlled by a current flowing through said inductor depending on a voltage.

21. The control device according to claim 18, wherein said displacement control element includes at least a pair of opposing electrodes to utilize an electrostatic force exerted when a voltage is applied between at least said pair of electrodes.

22. A display device comprising:
a display section which includes a large number of picture elements;
a large number of select lines each of which gives a selection/unselection instruction to said respective picture elements;
a large number of signal lines each of which supplies a picture element signal to said respective picture elements in a selected state; and
a large number of reset lines each of which supplies a reset signal to said respective picture elements in said selected state, wherein each of said picture elements includes:
a first rectifying element and a second rectifying element which are connected in series in a forward direction between two lines selected from one of said select lines, one of said signal lines, and one of said reset lines; and
a load which is connected between remaining one line and a connection point between said first rectifying element and second rectifying element.

23. The display device according to claim 22, wherein V1≧V2 over an entire operating period provided that:
a line selected from the one of said select lines, the one of said signal lines, and the one of said reset lines, to which a cathode of said first rectifying element is connected, is defined as a first line, and a line selected from the one of said select lines, the one of said signal lines, and the one of said reset lines, to which an anode of said second rectifying element is connected, is defined as a second line; and
V1 represents an electric potential of said first line, and V2 represents an electric potential of said second line.

24. The display device according to claim 23, wherein a selection period and said unselection period are set for each of said picture elements in said operating period, V2≦V3≦V1 in said unselection period provided that V3 represents an electric potential of said connection point.

25. The display device according to claim 24, wherein V1<V3 or V2>V3 while each of said circuit elements is actually selected in said selection period.

26. The display device according to claim 25, wherein a reset period is set for each of said picture elements in said operating period; and
V1<V3 or V2>V3 while each of said circuit elements is actually reset in said reset period.

27. A method of driving a display device, said display device comprising:
a display section which includes a large number of picture elements;
a large number of select lines each of which gives a selection/unselection instruction to said picture elements;
a large number of signal lines each of which supplies a picture element signal to said picture elements in a selected state; and
a large number of reset lines each of which supplies a reset signal to said picture elements in said selected state, each of said picture elements including:
a first rectifying element and a second rectifying element which are connected in series in a forward direction between two lines selected from one of said select lines, one of said signal lines, and one of said reset lines; and
a load which is connected between remaining one line and a connection point between said first rectifying element and said second rectifying element,
wherein a picture element in said selected state is driven so that V1<V3 or V2>V3; and
a picture element in an unselected state is driven so that V2≦V3≦V1,
provided that a line selected from the one of said select lines, the one of said signal lines, and the one of said reset lines, to which a cathode of said first rectifying element is connected, is defined as a first line, and a line selected from the one of said select lines, the one of said signal lines, and the one of said reset lines, to which an anode of said second rectifying element is connected, is defined as a second line; and
V1 represents an electric potential of said first line, V2 represents an electric potential of said second line, and V3 represents an electric potential of said connection point of said picture element.

28. The method of driving said display device according to claim 27, wherein a first voltage and a second voltage are applied to said load, and each of said picture elements has a light emission characteristic that light is emitted while said second voltage is applied.

29. The method of driving said display device according to claim 28, wherein a light emission luminance of said picture element is changed depending on a gradation level by changing an end time point of said second voltage by modulating a pulse width of said picture element signal supplied to said picture element depending on said gradation level of said picture element.

30. The method of driving said display device according to claim 28, wherein a light emission luminance of said picture element is changed depending on a gradation level by changing an amplitude of said second voltage by controlling an amplitude of said picture element signal supplied to said picture element depending on said gradation level of said picture element.

31. The method of driving said display device according to claim 28, wherein a light emission luminance of said picture element is changed depending on a gradation level by changing a start time point of said second voltage by modulating a phase of a trigger signal included in said picture element signal supplied to said picture element depending on said gradation level of said picture element.

32. The method of driving said display device according to claim 28, wherein a light emission luminance of said picture element is changed depending on a gradation level by changing an amplitude of said second voltage by modulating a pulse width of said picture element signal supplied to said picture element depending on said gradation level of said picture element.

33. The method of driving said display device according to claim 28, wherein said picture element has a characteristic that a light amount is changed depending on a duty ratio of a period of said first voltage with respect to a predetermined period, and
a light emission luminance of said picture element is changed depending on a gradation level by changing a pulse width of said first voltage by modulating a phase of a trigger signal included in said picture element signal supplied to said picture element depending on said gradation level of said picture element.

34. The method of driving said display device according to claim 28, wherein said picture element has a characteristic that a light amount is changed depending on an accumulated voltage in said first voltage, and
a light emission luminance of said picture element is changed depending on a gradation level by changing an amplitude of said first voltage state by modulating a pulse width of said picture element signal supplied to said picture element depending on said gradation level of said picture element.

35. The method of driving said display device according to claim 28, wherein said picture element has a characteristic that a light amount is changed depending on an accumulated voltage in said first voltage, and
a light emission luminance of said picture element is changed depending on a gradation level by changing an amplitude of said first voltage by modulating an amplitude of said picture element signal supplied to said picture element depending on said gradation level of said picture element.

36. The method of driving said display device according to claim 28, wherein said first voltage and said second voltage are continuously applied to said load.

37. The method of driving said display device according to claim 27, wherein said picture element has a light emission characteristic that a first voltage, a reference voltage, and a second voltage having a polarity opposite to that of said first voltage are applied to said load, and light is emitted at least while said first voltage is applied and while said second voltage is applied.

38. The method of driving said display device according to claim 37, wherein a light emission luminance of said picture element is changed depending on a gradation level by changing a start time point of said first voltage and a start time point of said second voltage by modulating a phase of a trigger signal included in said picture element signal supplied to said picture element depending on said gradation level of said picture element.

39. The method of driving said display device according to claim 37, wherein a light emission luminance of said picture element is changed depending on a gradation level by changing an amplitude of said first voltage and an amplitude of said second voltage by modulating a pulse width of said picture element signal supplied to said picture element depending on said gradation level of said picture element.

40. The method of driving said display device according to claim 37, wherein a light emission luminance of said picture element is changed depending on a gradation level by changing an amplitude of said first voltage and an amplitude of said second voltage by modulating an amplitude of said picture element signal supplied to said picture element depending on said gradation level of said picture element.

41. A method of driving an array of circuit elements, said array comprising a plurality of circuit elements, a plurality of first lead wires, a plurality of second lead wires, and a plurality of third lead wires, a first group comprising said plurality of first lead wires, a second group comprising said plurality of second lead wires, at least one of said first group and said second group giving a selection/unselection instruction to said circuit elements, and each of said circuit elements including:
a first rectifying element and a second rectifying element which are connected in series in a forward direction respectively between two lead wires selected from one of said first lead wires, one of said second lead wires, and one of said third lead wires; and
a load which is connected between remaining one lead wire and a connection point between said first rectifying element and second rectifying element,
wherein a selected circuit element in a selected state is driven so that V1<V3 or V2>V3; and
an unselected circuit element in an unselected state is driven so that V2≦V3≦V1,
provided that a lead wire selected from one of said first lead wires, one of said second lead wires, and one of said third lead wires, to which a cathode of said first rectifying element is connected, being defined as a first lead wire, and a lead wire selected from one of said first lead wires, one of said second lead wires, and one of said third lead wires, to which an anode of said second rectifying element is connected, being defined as a second lead wire; and
V1 represents an electric potential of said first lead wire, V2 represents an electric potential of said second lead wire, and V3 represents an electric potential of said connection point.

42. A method of driving a control device, said control device comprising:
a plurality of circuit elements;
a large number of select lines each of which gives a selection/unselection instruction to said respective circuit elements;
a large number of signal lines each of which supplies a signal to said respective circuit elements in a selected state; and
a large number of reset lines each of which supplies a reset signal to said respective circuit elements in said selected state, wherein each of said circuit elements includes:
a first rectifying element and a second rectifying element which are connected in series in a forward direction respectively between two lines selected from one of said select lines, one of said signal lines, and one of said reset lines; and
a load which is connected between remaining one line and a connection point between said first rectifying element and second rectifying element,
wherein a selected circuit element in said selected state is driven so that V1<V3 or V2>V3; and
an unselected circuit element in an unselected state is driven so that V2≦V3≦V1,
provided that a line selected from one of said select lines, one of said signal lines, and one of said reset lines, to which a cathode of said first rectifying element is connected, is defined as a first line, and a line selected from one of said select lines, one of said signal lines, and one of said reset lines, to which an anode of said second rectifying element is connected, is defined as a second line; and
V1 represents an electric potential of said first line, V2 represents an electric potential of said second line, and V3 represents an electric potential of said connection point.

43. A method of driving a control device, said control device comprising a plurality of circuit elements, each of said circuit elements including:
a first lead wire which gives a displacement instruction in a positive direction, a second lead wire which gives a displacement instruction in a negative direction, a third lead wire which gives a displacement amount instruction, a first rectifying element and a second rectifying element which are connected in series in a forward direction between said first lead wire and said second lead wire, and a load which is connected between said third lead wire and a connection point between said first rectifying element and said second rectifying element,
wherein a circuit element, for which said displacement instruction in said positive direction is given, is driven so that V1≧V2 and V3<V1 at a displacement start time point;
a circuit element, for which said displacement instruction in said negative direction is given, is driven so that V1≧V2 and V3<V2 at a displacement start time point; and
a circuit element, which is in an unselected state, is driven so that V2≦V3≦V1,
provided that V1 represents an electric potential of said first lead wire, V2 represents an electric potential of said second lead wire, and V3 represents an electric potential of said connection point.
